(19) United States
(12) Patent Application Publication
(10) Pub. No.: US 2025/0034918 A1
(43) Pub. Date: Jan. 30, 2025

(54) LATCHING SYSTEM FOR A CLOSURE PANEL

(71) Applicant: Magna Closures Inc., Newmarket (CA)

(72) Inventor: John DISTEFANO, Newmarket (CA)

(21) Appl. No.: 18/764,299

(22) Filed: Jul. 4, 2024

Related U.S. Application Data
(60) Provisional application No. 63/529,394, filed on Jul. 28, 2023.

(51) Int. Cl. E05B 83/24; E05B 81/04; E05B 81/14; E05B 81/20

(52) U.S. Cl. CPC E05B 83/243; E05B 81/04; E05B 81/20; E05B 81/14

(57) ABSTRACT

An actuation system for facilitating opening and closing of a closure panel of a vehicle, the actuation system including one or more mechanisms of a latch mechanism; a release mechanism; a cinching mechanism; an offset pop-up spring and a service release mechanism.

### CROSS-REFERENCE TO RELATED APPLICATION

This application claims the benefit of U.S. Provisional Application Ser. No. 63/529,394, filed Jul. 28, 2023, which is incorporated herein by reference in its entirety.

### FIELD

This disclosure relates to latching systems for a closure panel.

### BACKGROUND

Some vehicles are equipped with a closure panel, such as a lift gate, which is driven between an open position (position 2) and a closed position (position 1) using an electrically driven lift or opening system. Disadvantages of the current systems include bulky form factors which take up valuable vehicle cargo space, for example, occupying space along the vertical supports delimiting the opening and access to a rear liftgate or what is commonly referred to as a frunk (a storage space accessed via a front hood of a battery powered vehicle).

In current state of the art, when one cinches a frunk closed there can be an issue of a larger pop-up spring needed to cinch against. Also now with frunks, one needs seals to seal the luggage compartment, so the presence of these seals can add extra spring force the cinch motor has to fight against. And further, it is recognized that the more one compresses the seal/spring combination, the forces required to be exerted by the motor can increase exponentially.

Further, in state of the art latches, the over travel is built in with tolerances, i.e. the ratchet is over traveled during cinching operations in order to compensate for wear and tolerances that may eventually cause the ratchet to not be properly cinched past the primary position of the latch, recognizing that the latch would not be securely closed in this case.

Further, when one adds a cinching latch to a frunk, which inherently has a larger spring and extra seal loads, the process of over travel undesirably now requires a larger motor, and/or more gear reductions. However, more gear reductions has the disadvantage of slowing latch functions, especially if one uses the motor for both release and pop-up speed reduction. Larger motors are also more expensive and increases packaging space.

### SUMMARY

It is an object of the present invention to provide an actuation system that obviates or mitigates at least one of the above presented disadvantages.

One aspect provided is a latching system for facilitating opening and closing of a closure panel of a vehicle, the actuation system comprising: a latch mechanism; a cinching mechanism; and an anti-pop-up feature limiting over travel of the latch mechanism in order to provide a controlled release of stored pop-up energy.

A further aspect provided is a latching system for facilitating opening and closing of a closure panel of a vehicle, the actuation system comprising:
a latch mechanism; a cinching mechanism employing a first gear ratio; and a release mechanism employing a second gear ratio; wherein the first gear ratio is higher than the second gear ratio in order to obtain different speed of operation between a release operation and a cinching operation.

A further aspect provided is a latching system for facilitating opening and closing of a closure panel of a vehicle, the actuation system comprising: a latch mechanism; a cinching mechanism; and a pop-up spring coupled to the cinching mechanism in order to provide a first moment arm and a second moment arm, the first moment arm different from the second moment arm in order to reduce engagement effort of the latch mechanism while increasing load capability of the cinching mechanism.

A further aspect provided is a latching system for facilitating opening and closing of a closure panel of a vehicle, the actuation system comprising: a latch mechanism; release mechanism; and a service release mechanism coupled to the release mechanism; wherein the service release mechanism is configured to operate in multiple latch positions irrespective of one or more latch components being outside of their respective home position.

A further aspect provided is a latching system for facilitating opening and closing of a closure panel of a vehicle, the actuation system comprising: a latch mechanism having a ratchet, the ratchet moveable between an overtravel position, a latched position and a released position; a cinching mechanism adapted to move the ratchet to the overtravel position, wherein the overtravel position is variable.

A further aspect provided is a latching system for facilitating opening and closing of a closure panel of a vehicle, the actuation system comprising: a ratchet, the ratchet moveable between an cinch overtravel position, a release overtravel position, a latched position and a released position; a pawl moveable between a ratchet holding position and a ratchet releasing position; and a motor adapted to move the ratchet to the cinch overtravel position during a cinching mode and adapted to move the pawl from the ratchet holding position to the ratchet releasing position and move the ratchet to the release overtravel position during a releasing mode; wherein the release overtravel position is less than the cinch overtravel position.

A further aspect provided is a latching system for facilitating opening and closing of a closure panel of a vehicle, the actuation system comprising: a ratchet adapted to engage a striker, the ratchet having a released position, a locked position, and an overtravel position; a pawl adapted to hold the ratchet in the locked position or release the ratchet from the locked position; and an actuator adapted to rotate the ratchet to the overtravel position, wherein actuator causes the rotation profile of the ratchet during a cinch mode that is different than the rotation profile of the ratchet during a power release mode.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a side view of a vehicle with one or more closure panels;

FIG. 2 is a front view of a vehicle with one or more closure panels illustrating a latching mechanism;

FIG. 3 is a side view of a vehicle with one or more closure panels with seals;

FIG. 4 shows an embodiment of a latching system of the vehicle of FIG. 1;

FIG. 5a is a view of the latching system of FIG. 4 in a secondary position;

FIG. 5b is a view of the latching system of FIG. 4 in a primary position;

FIG. 6 is one embodiment of an operation of a latching system of the vehicle of FIG. 1;

FIG. 7 is an alternative embodiment of an operation of the latching system of FIG. 4;

FIGS. 8-12 show operational steps of a cinching mechanism of the latching system of FIG. 4;

FIG. 13 shows an embodiment of a cinching cam of the cinching mechanism of FIG. 4;

FIG. 14 shows operational steps of the cinching mechanism of the latching system of FIG. 4;

FIG. 15 shows an embodiment of the cinching cam of FIG. 13;

FIG. 16 shows operational steps of the cinching mechanism and the release mechanism of the latching system of FIG. 4;

FIG. 17 shows operational steps of the cinching mechanism and the release mechanism of the latching system of FIG. 4;

FIGS. 18-19 show an embodiment of the latching system of the vehicle of FIG. 1 with a release mechanism;

FIGS. 20-27 show operational steps of the release mechanism of the latching system of FIGS. 18-19;

FIG. 28 show an embodiment of the latching system of the vehicle of FIG. 1 with a service lever release mechanism; and

FIGS. 29-31, 32a,b, 33 show operational steps of the service lever release mechanism of the latching system of FIG. 28.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

In the following description, details are set forth to provide an understanding of the disclosure. In some instances, certain software, circuits, structures, techniques and methods have not been described or shown in detail in order not to obscure the disclosure. The term “controller” is used herein to refer to any machine for processing data, including the data processing systems, computer systems, modules, electronic control units (“ECUs”), microprocessors or the like for providing control of the systems described herein, which may include hardware components and/or software components for performing the processing to provide the control of the systems described herein. A computing device is another term used herein to refer to any machine for processing data including microprocessors or the like for providing control of the systems described herein. The present disclosure may be implemented in any computer programming language (e.g. control logic) provided that the operating system of the control unit provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

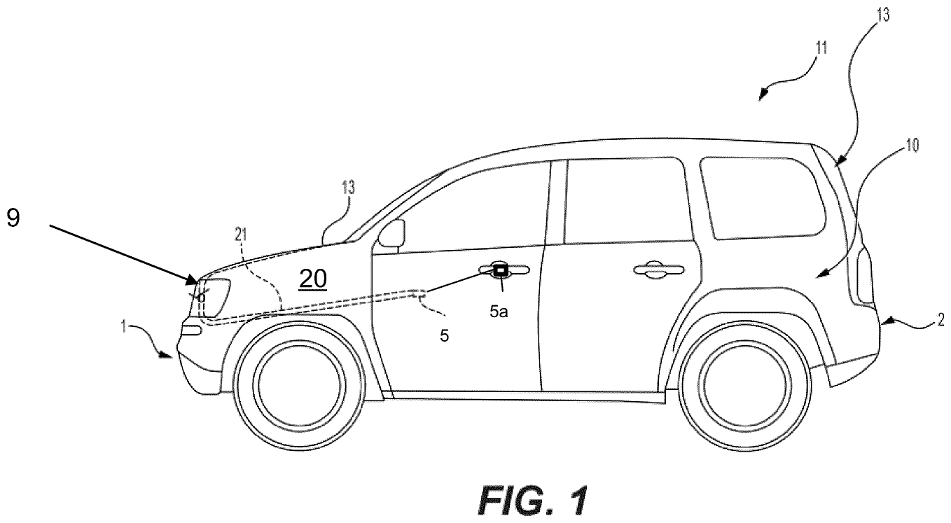

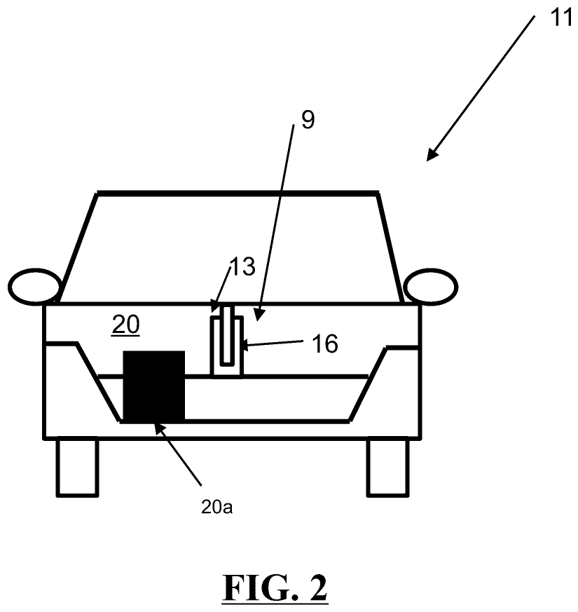

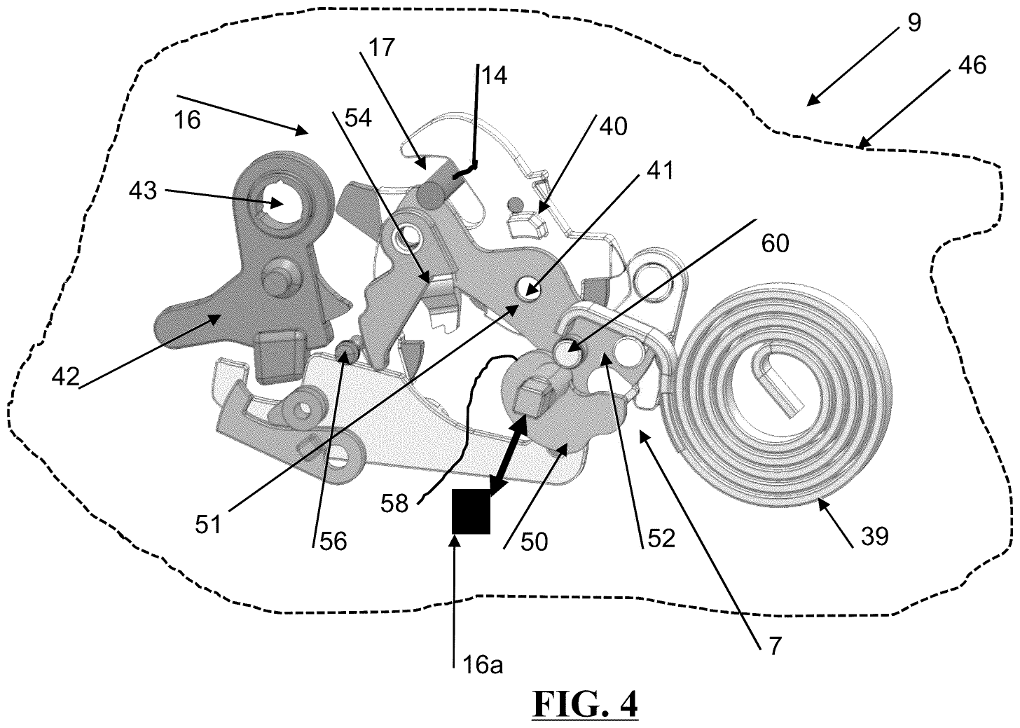

Referring to FIGS. 1 and 2, provided is a latch system 9 for a closure panel 13 (e.g. enclosing a storage space or frunk 20). In one embodiment, as shown, a hinge 12 of the closure panel 13 is mounted to a body 10 of a vehicle 11, while a latch 16 is mounted on the body 10 and a mating latch component 14 (see FIG. 4) is mounted on the closure panel 13 (e.g. a hood). In an alternative embodiment, the latch 16 can be mounted to the closure panel 13 of the vehicle 11, while the mating latch component 14 can be mounted on the body 10. The closure panel 13 preferably has seals 13a (e.g. resilient foam, rubber, etc.) between the closure panel 13 and the body 10 of the vehicle 11.

The vehicle 11 can have one or more controls (e.g. button, switch, proximity sensor of a mechanical handle, etc.) 5 for controlling an actuators 16a of the latch system 9, as further described below. Controls 5 may also be connected to a controller or control system 5a, such as centralized controller, for example a Body Control Module (“BCM”), or as a decentralized controller, for example a Latch Control Module (“LCM”). The control(s) 5 can be connected to the actuator 16a (e.g. linear, rotary, etc.) of the actuator system 9 by a respective connection 21 (e.g. Bowden Cable, electrical signal cable, and/or wireless connection—for example in relation to an appropriately configured wireless transmitter such as a FOB). In addition, the vehicle 11 has a front end 1 and a back end 2.

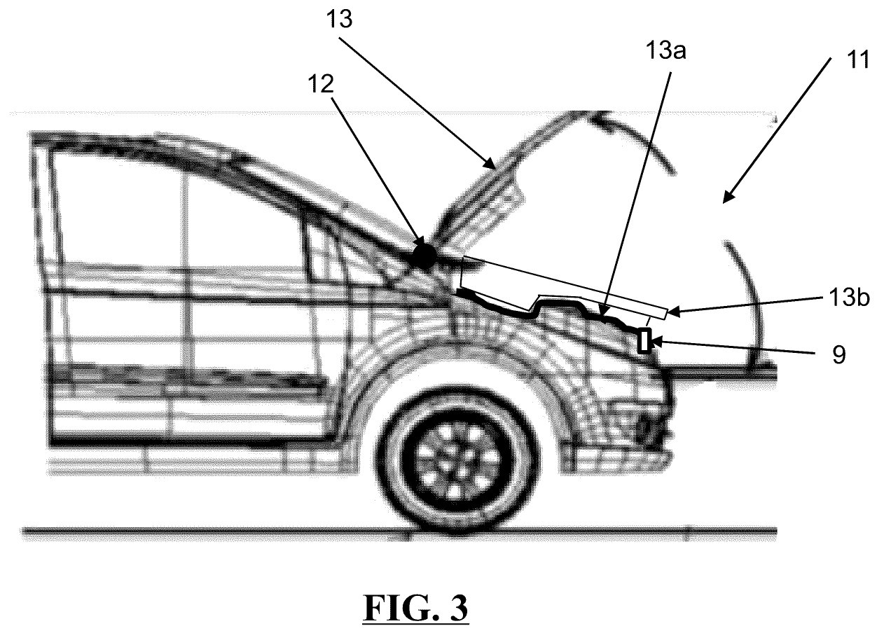

As shown in FIG. 2, the closure panel 13 can be used to cover an internal (e.g. storage) space 20 of the vehicle 11, and therefore as such can be used to provide for controlled closure and access to the space 20 (e.g. containing luggage 20a) as facilitated by the latch system 9. As further described below, operation of the closure panel 13 between a partially open position (see closure panel 13 in position indicated using reference number 13b in FIG. 3) and a closed position (see FIG. 1) can be assisted by an actuator mechanism 16a of the latch system 9. Partially opened position 13b may include a pop-up position the hood having been lifted by a spring/seal combination or a secondary latching position the hood having engaged the secondary locking position of latching system 9. It is also recognised that opening and closing of the closure panel 13 can be performed manually by a user of the vehicle 11. It is recognised that in the closed position the latch 16 can provide that the corresponding striker 14 and associated ratchet 40 to lock the closure panel 13 in the closed position (see FIGS. 1,10).

In view of the above, the latch system 9 be used advantageously with vehicle closure panels 13 to provide for open and close operations for the closure panel(s) 13 of vehicles 11. Other applications of the latch system 9, in general for closure panels 13 both in and outside of vehicle applications, include advantageously assisting in optimization of overall hold and manual effort forces for closure panel 13 operation. It is recognized as well that the latch system 9 examples provided below can be used advantageously as the sole means of open and close assistance for closure panels 13 or can be used advantageously in combination (e.g. in tandem) with other closure panel 13 biasing members (e.g. spring loaded hinges, biasing struts, etc. not shown). In particular, the latch system 9 can be used to provide or otherwise assist in a holding force (or torque) for the closure panel 13.

Referring again to FIGS. 1 and 2, shown is the vehicle 11 with the vehicle body 10 having one or more closure panels 13. For vehicles 11, the closure panel 13 can be referred to as a partition or door, typically operated in a hinged fashion, but sometimes attached by other mechanisms such as tracks, in front of an opening which is used for entering and exiting the vehicle 11 interior by people and/or cargo (e.g. luggage). It is also recognized that in some applications, the closure panel 13 could be used as an access panel for vehicle 11 systems such as engine compartments and also for traditional trunk compartments of automotive type vehicles 11. The closure panel 13 shown in FIG. 1 is illustratively shown as an access panel for a frunk or storage area 20 when the vehicle 11 is provided having an electric powertrain or provided with an internal combustion engine located elsewhere in the vehicle 11, such as at the rear. Compared to traditional engine bay compartments located at the front of the vehicle not requiring seals to prevent ingress of the elements such as rain/dirt/snow into the engine bay, the frunk or storage area 20 requires sealing to ensure items (e.g. luggage, groceries) stored are protected against the elements.

The closure panel 13 can be opened to provide access to the space 20, or closed to secure or otherwise restrict access to the space 20. For example decklids, frunks (e.g. front trunk), hoods, tailgates can be referred to as the closure panel 13. It is also recognized that there can be one or more intermediate hold positions of the closure panel 13 between a fully open position and fully closed position, as provided at least in part by the actuator 16a. For example, the actuator 16 can assist in biasing movement of the closure panel 13 away from one or more intermediate hold position(s), also known as Third Position Hold(s) (TPHs) or Stop-N-Hold(s), once positioned therein, as the actuator 16a acts on the respective latch 16 as further described below.

Referring to FIG. 4, shown is one embodiment of the latch system 9. For example, the latch 16 of the latch system 9 can include a ratchet 40 and a primary pawl 42, such that the primary pawl 42 retains the ratchet 40 in a latched position (i.e. holding the mating latch component 14 within a slot 17 of the ratchet 40). The ratchet 40 pivots about a ratchet pivot axis 41 and the pawl 42 pivots about a pawl pivot axis 43, for example, as the latch 16 is operated between the latched position and an unlatched position (i.e. when the mating latch component 14 is allowed to exit the slot 17). The ratchet 40 and the pawl 42 are mounted to a latch frame 46 (e.g. by pins not shown), shown in ghosted view by example. It is recognized that the latch system 9 is mounted to the closure panel 13 or the vehicle body 10 by the latch frame 46. For example, it is recognized that movement of the pawl 42 about the pawl pivot 43 causes the pawl 42 to disengage from the ratchet 40 and thus facilitate the ratchet 40 to pivot about the ratchet pivot 41 and thus allow the mating latch component 14 to exit the slot 17. Similarly, restricting movement of the pawl 42 about the pawl pivot 43 (e.g. by a pawl biasing element such as a torsion spring as is known in the art) causes the pawl 42 to maintain engagement with the ratchet 40 and thus inhibit the ratchet 40 to pivot about the ratchet pivot 41 and thus retain the position of the mating latch component 14 within the slot 17 and the closure panel 13 in a closed position.

Referring again to FIG. 4, the latch system 9 also has a cinching mechanism 7 including a cinch cam 50, a lift lever 52, and a cinch pawl 54. The motion of the cinch pawl 54 is guided by a cinch pawl guide rivet 56. During operation (as controlled by the actuator 16a), a cam surface 58 of the cinch cam 50 rides along a lift lever roller 60 mounted on the lift lever 52. As further described below, the cinch cam 50 is used to control the position of the lift lever 52, which rotates about lever axis 51 (e.g. which can be the same as that of the ratchet 40). Advantageously, the use of the cinch cam 50 provides for the actuator 16a to control the pop up speed of the latch 16, and thus of the closure panel 13. With this added flexibility, the presence of the cinch cam 50 (coupled to the lift lever 52 via the lift lever roller 60) provides for the cinch pawl 54 to have a pair of engagement positions, as further described below, the first engagement position is used during cinching operation of the cinch mechanism 7 and the second engagement position is used during release of the latch mechanism 16. An advantage of the two engagement positions is that a reduction in overtravel (as compared to state of the art cinching systems without the pair of engagement positions) of the cinching mechanism 7 can be facilitated in order to provide for a desired anti-pop-up function of the latching system 9. As further described below, a pop-up spring 39 (e.g. resilient element such as a torsion spring) has an offset center from the lift lever pivot axis 51, thus providing a maximum moment arm at the pop-up position and a smaller (as compared to the maximum) moment arm in the primary position. In this sense, even though the spring force of the spring 39 increases as the latch 16 approaches the primary (e.g. locked position), the decreasing moment arm provides for a flatter load curve. As such, the configuration of the pop-up spring 39 provides for a flatter load curve to help reduce engagement effort of the cinching mechanism 7 and thus help improve cinch load capability.

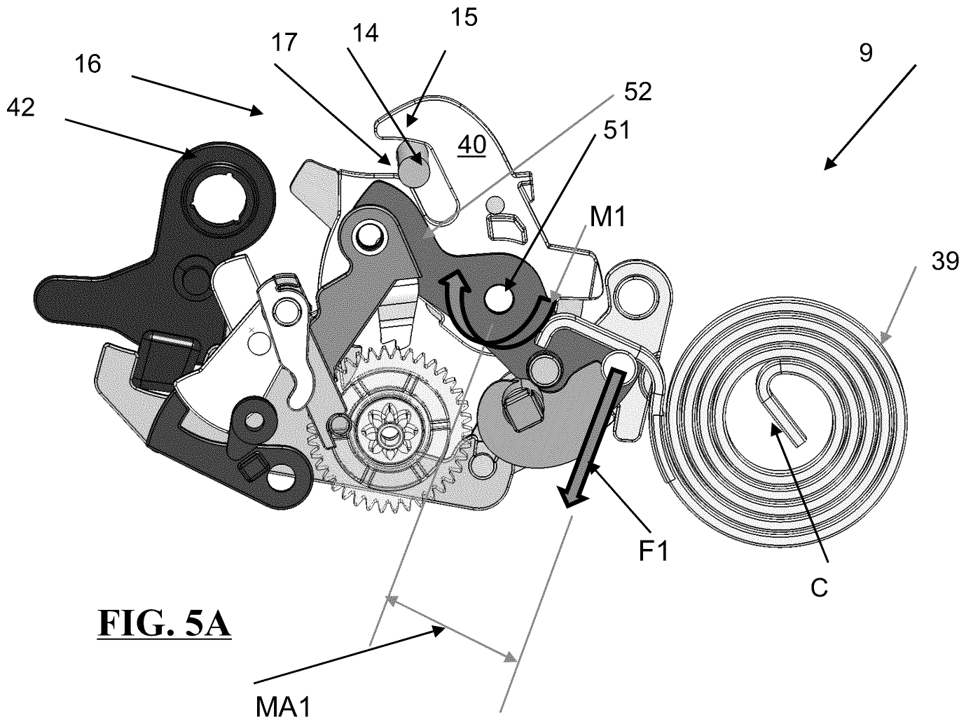

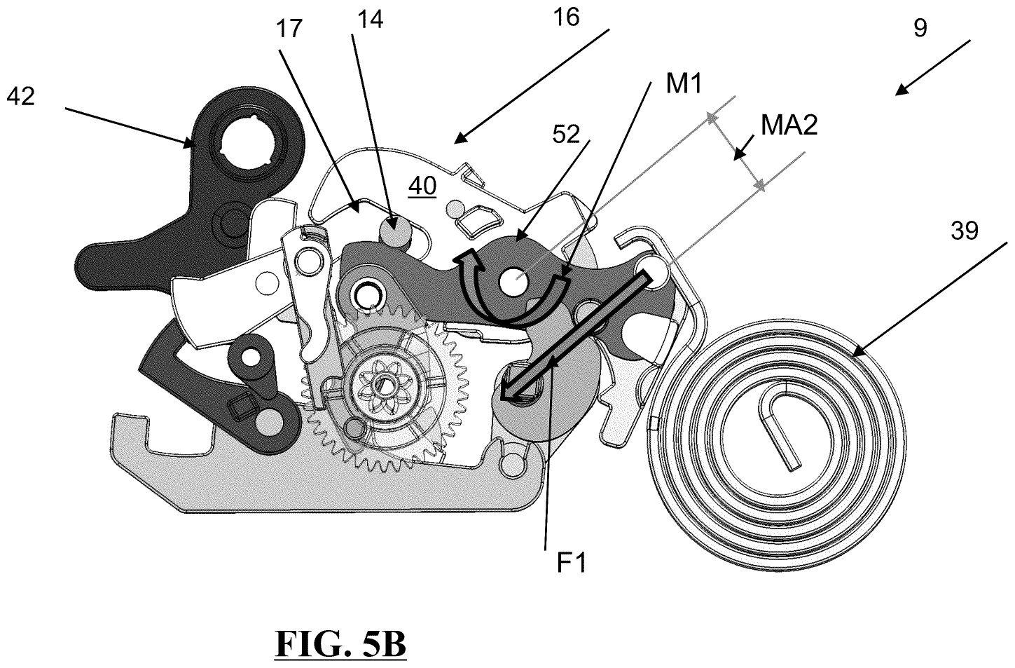

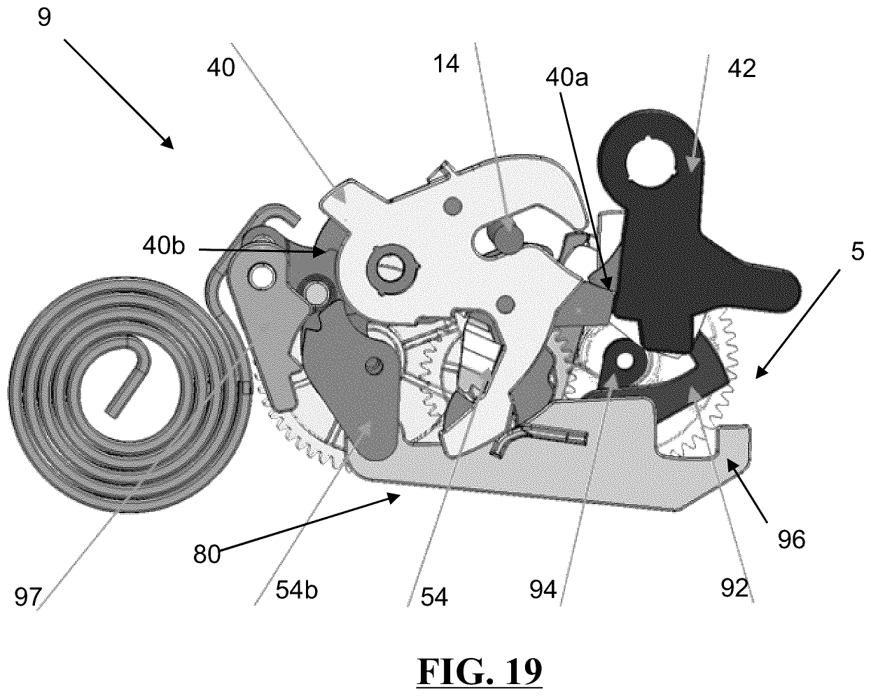

Referring to FIG. 5a, the latch 16 is shown in the pop-up (e.g. secondary position) state, such that the mating latch component 14 is still retained by a hook 15 of the ratchet 40 and secondary pawl 54b engaging prevents the ratchet 40 from rotating towards the fully open position via secondary pawl 54b engaging secondary notch 40b of ratchet 40—see FIG. 19. In FIG. 5b, the latch 16 is shown in the primary (e.g. latched) state, such that the mating latch component 14 is retained by the slot 17 of the ratchet 40 and rotation of the ratchet 40 is inhibited by the primary pawl 42 in engagement with the ratchet 40. Referring again to FIG. 5a, the Pop-Up spring 39 uses a torsion design whose centre C is offset from the Lift Lever pivot 51. This design has a maximum moment arm MA1 at the pop-up position (see FIG. 5a) and a smaller moment arm MA2 in primary position (see FIG. 5b). Even through the spring force F1 increases to spring force F2 as the latch 16 approaches the primary position (from the secondary position), the decreasing moment arm MA1 to the moment arm MA2 results in a flatter load curve of the spring 39. It is recognized that the resultant lift lever moments M1, M2 are as shown. Therefore, as the Lift Lever 52 moves from the secondary position towards the primary position of the latch 16, the Pop-Up Spring force F1, F2 increases but the moment arm MA1, MA2 also decreases. As a result, the net moment on the Lift Lever 52 follows a much flatter curve and does not significantly increase through the Lift Lever 52 travel about the pivot 51.

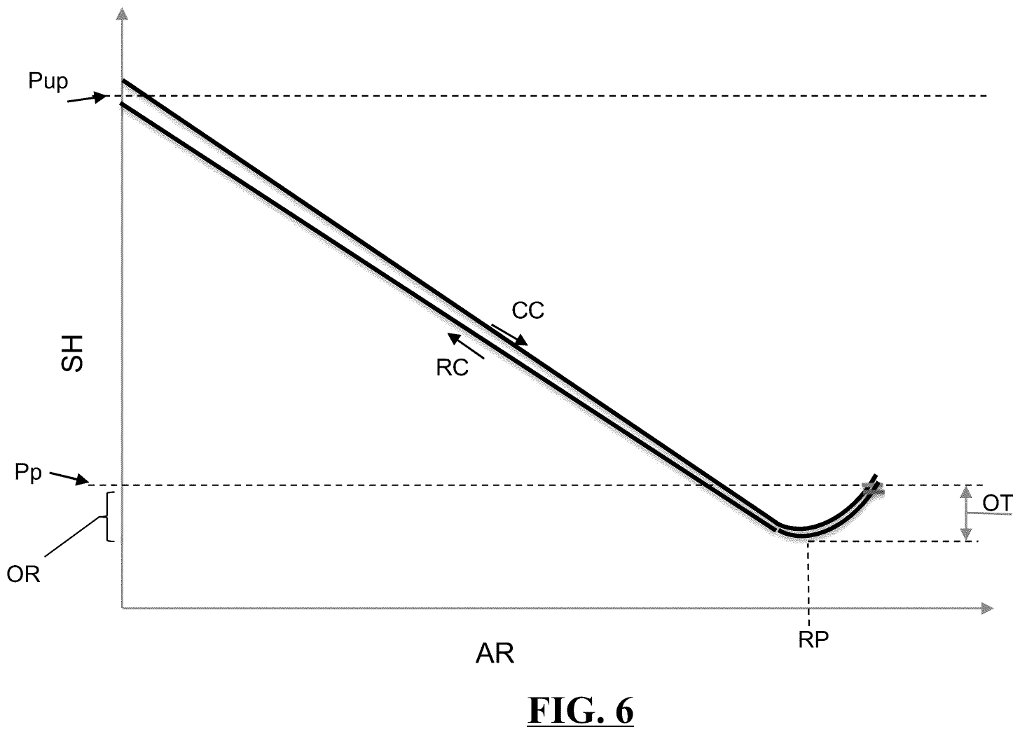

For cinch mechanism 7 operation, for frunk 20 applications, cinch over travel is provided in order to provide that the pawl 42 will engage the ratchet 40 of the latch 16, in view of additional resistance being encountered for the seal loads and the pop-up spring 39. Thus with a system having no pop-up spring or seal loads for example, traditional cinch over travel can follow the same profile during over travel release as during the cinch operation due to the same control cam surface acting at the same striker position, see FIG. 6 showing Cinch Cycle with symmetrical Cinch/Anti-Pop Off control. Thus, such a system applied to a system having a pop-up spring and seal loads for example, in both cinch and release the large pop-up spring and seal loads have to be overcome during the large over travel. As over travel increases, the spring forces increases rapidly, needing a larger motor and/or additional torque multiplication/speed reduction components to meet the over travel position. For this cinch strategy to work, the striker is cinched into an over travel position. The amount of over travel can be large enough to account for production tolerances of all components and need to account for any wear or travel loss over the life of the latch. As noted, insufficient over travel would result in a latch that does not achieve primary position consistently. Shown is Strike Height SH verses Actuator Rotation AR. Levels shown are Primary Position Pp, Pop-up Position Pup, overtravel region OR and magnitude of overtravel OT. Also shown is the release point RP (during the release cycle), as well as the release curve operation RC and cinch curve operation CC.

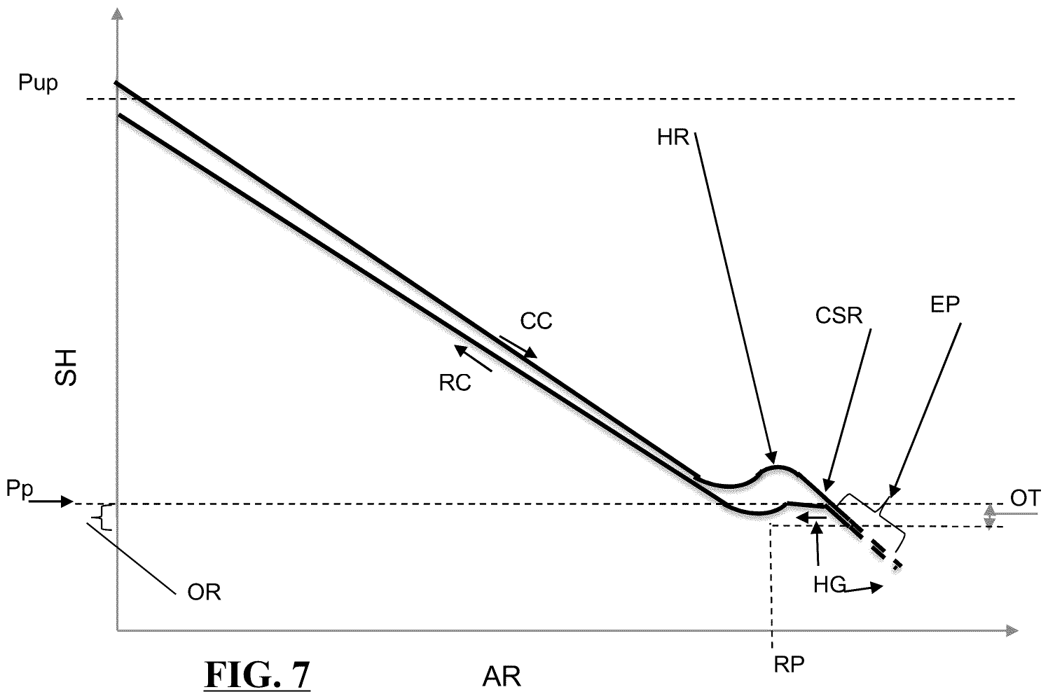

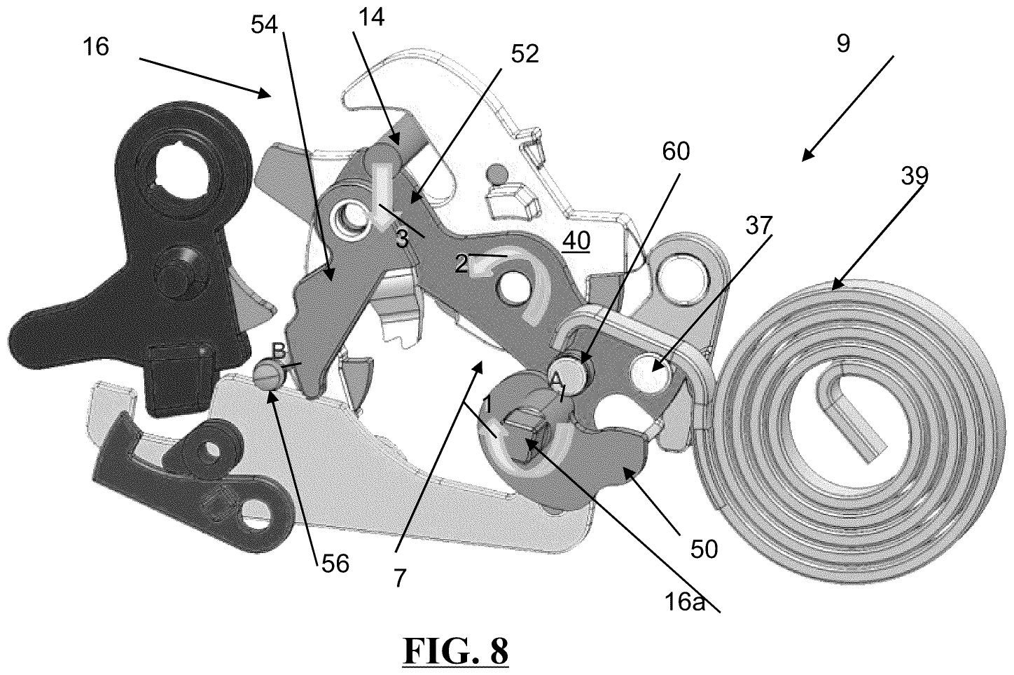

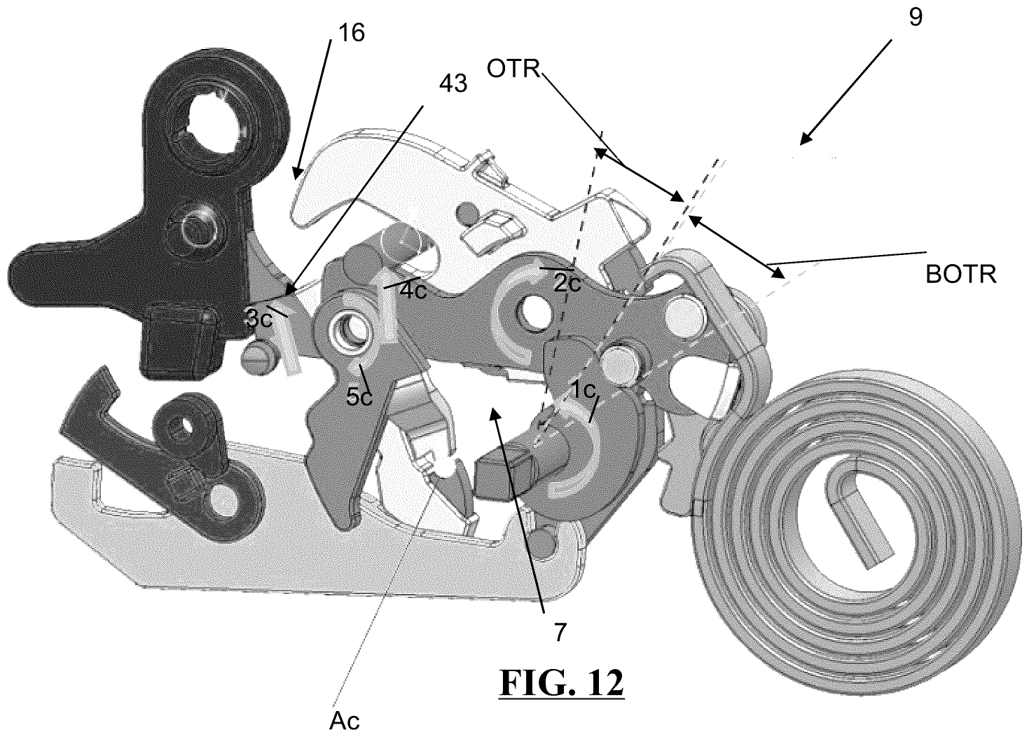

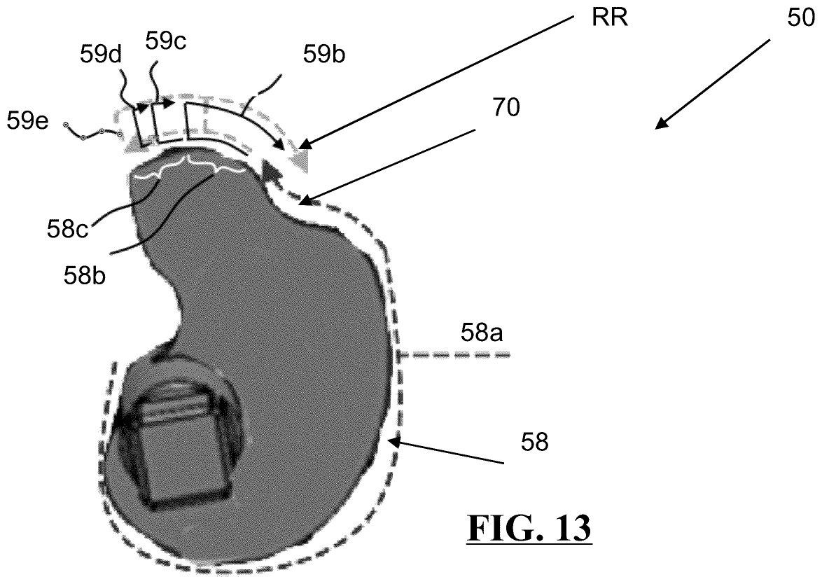

In view of the above, referring to FIG. 7, shown in the operation of the latching system 9 (see FIG. 4), referring to the current configuration using a Cinch Cycle CC with asymmetrical Cinch/Anti-Pop Off control. In FIG. 7, shown is striker height SH vs cam rotation AR for cinch operation CC as well as release operation RC. In particular, the curves show an over travel region OR, which is reduced during release over travel due to the cinch pawl 54 extension acting on the ratchet 40 (see FIGS. 8, 9, 10, 11, 12). As a result the spring and seal load do not need to be compressed as much, thus reducing motor 16a output/strain during the release cycle. Since the release cycle RC accounts for half of the operational life cycle of the motor 16a, reducing the output power required to complete the release operation can reduce wear to the motor and thus increase reliability and durability of the motor 16a during the cinch cycle. Alternatively, the motor 16a size/output can be reduced. Or, additional seal load can be introduced into the system as the reduced over travel will not compress the larger seal load to a point where resistance rapidly increases. Also shown in FIG. 7 is a hump region HR due to a notch 70 (see FIG. 13) in cinch cam surface 58 (of cam surface region CSR) to facilitate the roller 60 to sit (as shown in FIG. 12) allowing for the cinch extension 55 to move into place.

Also shown in FIG. 7 is a cam surface region CSR, such that cinch over travel provides the pawl 42 will engage ratchet 40. As such, cinch overtravel does not follow the same profile during the release cycle RC operation, as during cinch cycle CC operation due to the different control cam surfaces acting at the same striker 14 position depending on the cinch or release modes. Also shown is a variable cinch end position EP, depending on detected primary pawl 42 engagement with the ratchet 40, as well as a homing operation HG.

In view of the above, for this cinch strategy to operate, the striker 14 does not need to be excessively over-travelled during the cinch operation nor consistently over travelled over the life of the latch 9. However, the actuator 16a can be cycled further to compensate for tolerances and wear to provide that the latch mechanism 16 engages to the primary position when required e.g. in the event the pawl 42 is not engaging the ratchet 40 due to insufficient overtravel. Further, a reduced and smaller amount of over travel can be introduced during the release cycle to relieve the lift spring 39 and seal load at the release point. It is noted that insufficient over travel during the release cycle would not inhibit the latch mechanism 16 from achieving the primary position as compared to insufficient over travel during the cinch cycle would inhibit the latch mechanism 16 from achieving a primary locked state.

Referring to FIG. 8, shown is the start of the cinch cycle, such that the latch mechanism 16 is in secondary position with the striker 14 resting on the lift lever 52. Striker 14 may have been caused to move to the secondary position via gravity, a user moving the closure panel 13 towards the primary latched position, or via movement of the closure panel 13 using a powered actuator. At the first step, shown by arrow indicated by reference 1, the actuator 16a (shown symbolically) rotates the cinch cam 50 which contacts the lift lever roller 60 at point A. At the second step, shown by arrow indicated by reference 2, the lift lever 52 rotates and thus compresses the pop up spring 39 (the lever 52 is coupled to the spring 39 by coupling point 37). At the third step, shown by arrow indicated by reference 3, the weight of the closure panel 13 provides for the striker 14 and the ratchet 40 to follow the motion of the lift lever 52. Due to contact between the cinch pawl 54 and the cinch pawl guide rivet (e.g. abutment) 56 at point B, the cinch pawl 54 does not engage the ratchet 40 during this initial phase of the cinch cycle operation. As shown in FIG. 8, this portion of the cinch cycle operation (see FIG. 7) is referred to as a soft cinch as the closure panel 13 would not pose an undue pinch risk as the closure panel 13 is moving towards the closed position under the effect of the weight of the closure panel 13, and without the latch mechanism 16 power cinching the closure panel 13. For example lift lever 52 may be retracted to allow the closure panel 13 to move towards the closed position, without cinch lever 52 being driven for imparting a closing rotation of ratchet 40.

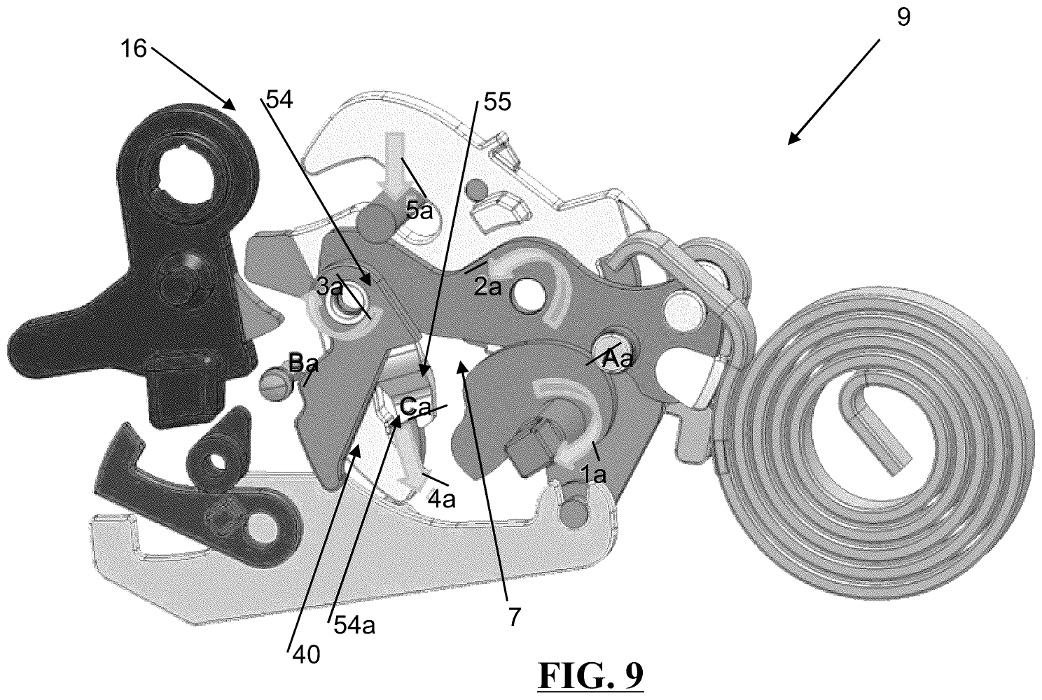

Referring to FIG. 9, at the first step, shown by arrow indicated by reference 1a, the actuator 16a continues to rotate the cinch cam 50 which contacts the lift lever roller 60 at point Aa. At the second step, shown by arrow indicated by reference 2a, the lift lever 52 rotates and compresses the pop-up spring 39. At the third step, shown by arrow indicated by reference 3a, as the cinch pawl 54 moves past the cinch pawl guide 56 at point Ba, a step 54a of the cinch pawl extension 55 rotates into engagement with the ratchet 40 at point Ca, noting that the cinch pawl extension 55 moves conjointly with the main body of the cinch pawl 54. At the fourth step, as the lift lever 52 continues to rotate, the cinch pawl 54 applies a force 4a shown by arrow indicated by reference 4a. Further, the ratchet 40 applies a cinching force 5a shown by arrow indicated by reference 5a to the striker 14. This portion of the cinch cycle operation (see FIG. 7) can be referred to as a hard cinch, as the actuator 16a is able to provide a force directly to the striker 14 through the ratchet 40 (via engagement of the cinch pawl 54 with the ratchet 40 as shown).

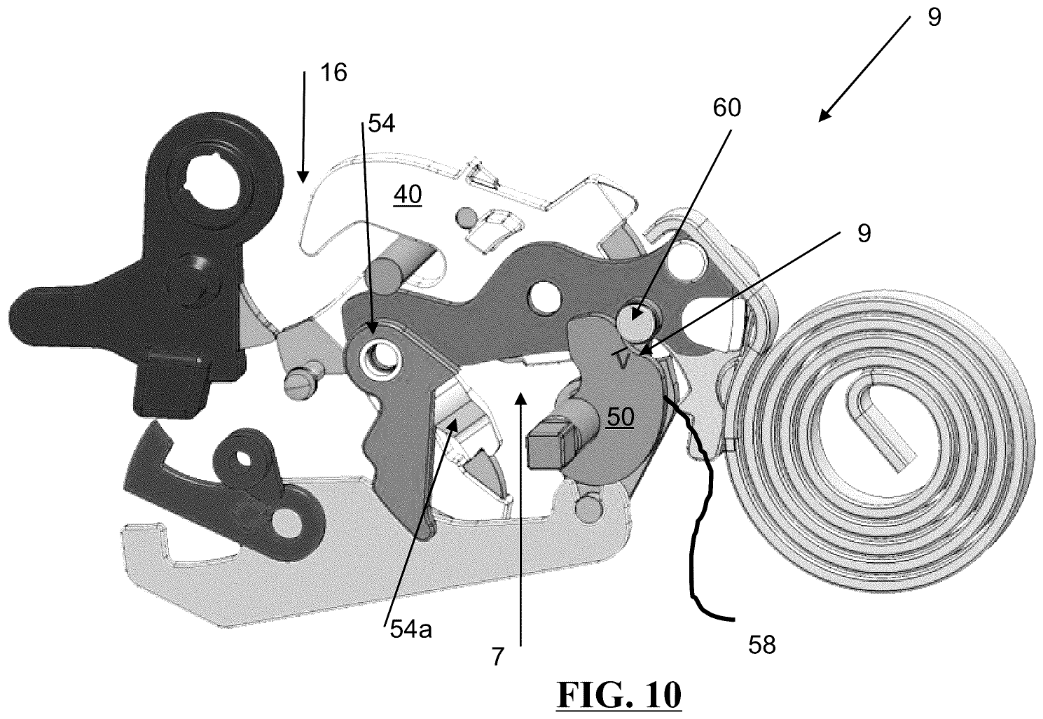

Referring to FIG. 10, the cinch cycle operation (see FIG. 7) continues from that of the position shown in FIG. 9. As the ratchet 40 approaches the primary position, due to the notch 70 (e.g. a valley) in the cam surface 58 at point V, the lift lever 52 and the ratchet 40 momentarily can move in a direction opposite to that of the cinching direction. It is recognized that this change in direction of the motion of the ratchet 40/lift lever 52 is optional for the cinching function, however can be advantageous for the subsequent release cycle operation if the cam 50 is to operate using less than approximately 270 degrees of rotation for example as shown. In an alternative configuration allowing more rotation of the cam 50, notch 70 may not be provided or may be moved to a different profile of the cam 50 not used during the cinch cycle, but only release cycle. (see FIG. 7) as further described below with an anti-pop-up function.

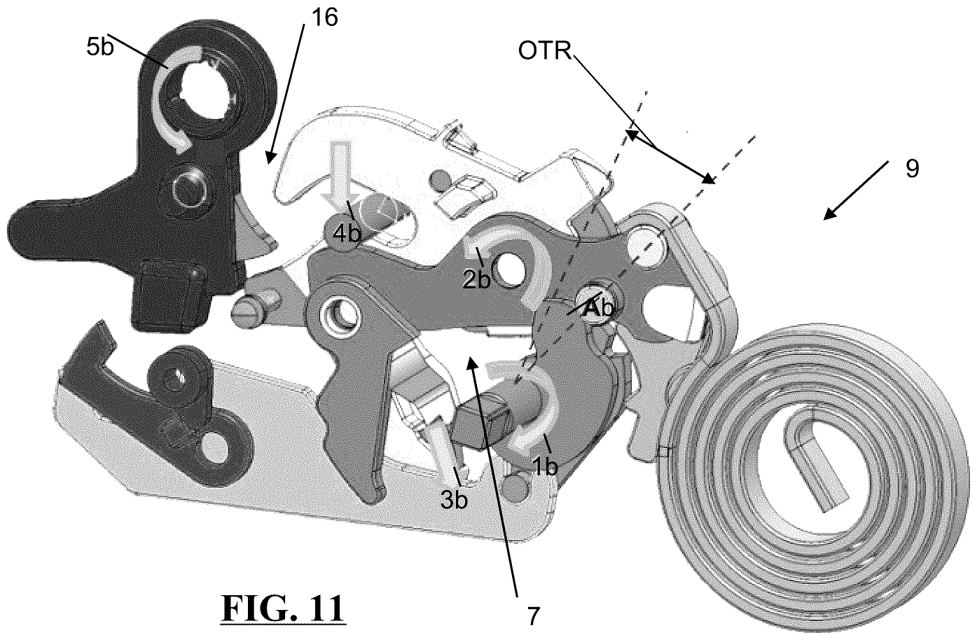

Referring to FIG. 11, at the first step shown by arrow indicated by reference 1b, the actuator 16a continues to rotate the cinch cam 50 which in turn contacts the lift lever roller 60 at point Ab. At the second step shown by arrow indicated by reference 2b, the lift lever 52 rotates and compresses the pop-up spring 39. At the third step as the lift lever 52 continues to rotate, the cinch pawl 54 applies a force 3b shown by arrow indicated by reference 3b directly to the ratchet 40. Similarly, at the fourth step the ratchet 40 applies a cinching force 4b shown by arrow indicated by reference 4b directly to the striker 14. At the fifth step shown by arrow indicated by reference 5b, the primary pawl 42 rotates into primary engagement with the ratchet 40. This portion of the cinch cycle operation (see FIG. 7) can also be referred to as a hard cinch, as the actuator 16a is able to provide a force directly to the striker 14 through the ratchet 40 (via engagement of the cinch pawl 54 with the ratchet 40 as shown). It is recognized that concerning the overtravel rotation range OTR for the cinch operation, this range is not used during the overtravel release so during the overtravel release, the motor is preferably under reduced stress.

Referring to FIG. 12, the end of the cinch cycle operation (see FIG. 7) is shown in summary, such that the latch mechanism 16 is in the primary position and the actuator 16a reverses back to its home position. At the first step shown by arrow indicated by reference 1c, the actuator 16a reverses rotation and the cinch cam 50 rotates towards the home position. At the second step shown by arrow indicated by reference 2c, the lift lever 52 rotates due to the force applied by the pop-up spring 39 at coupling point 37. At the third step shown by arrow indicated by reference 3c, the ratchet 40 rotates to rest on the primary pawl 42 (e.g. at engagement abutment/tooth 43). At the fourth step shown by arrow indicated by reference 4c, the lift lever 52 continues to rotate until the striker 14 is held and thus engaged by the ratchet 40. At the fifth step shown by arrow indicated by reference 5c, the cinch pawl 54 is able to rotate further into engagement with the ratchet 40 in preparation for the subsequent release cycle operation (see FIG. 7). It is noted at point Ac that an adjacent surface of the cinch pawl extension 54a now has a gap with the exterior adjacent surface of the ratchet 40. In this manner, adding of extra length can compensate for the cinch cam 50 not being rotated over the cinch over travel range OTR again during the release cycle, thus helping to reduce the degree for the actuator 15a (e.g. motor) to compress the spring 39 and the seal loads compared to the cinch operation. As such, the actuator 16a can be relieved from supporting the spring 39 and seal loads as the pawl 42 is now supporting the loading directly. Also shown is a backout/lost motion overtravel range BOTR as fixed, which is experienced during camming out of the notch.

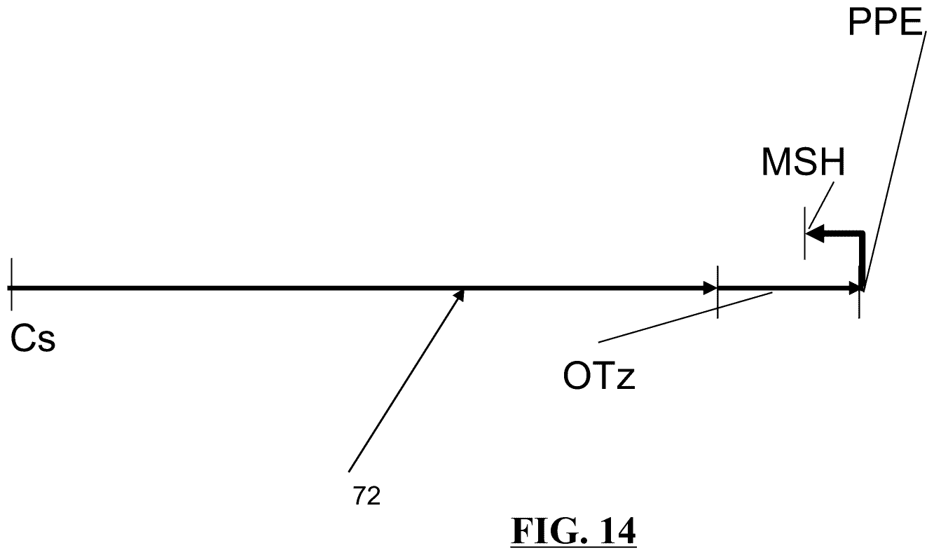

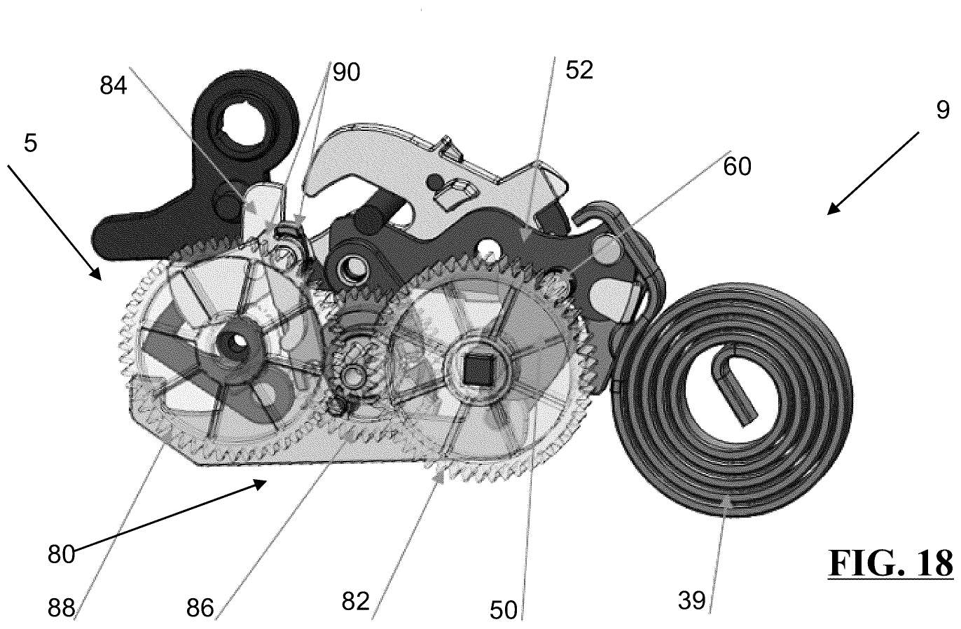

Referring to FIG. 13, shown is an example cinch cam 50 having the cam surface 58 with the notch 70, such that the cam surface 58 can be separated into a primary cinch surface 58a and a secondary cinch surface 58b, such that the primary cinch surface 58a and the secondary cinch surface 58b are divided by the notch 70. For example, maximum ratchet 40 over travel position can be determined by secondary cam cinch surface when the motor actuator 16a is stopped to facilitate the primary pawl 42 into engagement with the ratchet 40. The actuator 16a can be variably further advanced to facilitate extra over travel and primary pawl 42 engagement to compensate for any wear and change in tolerances of the latch mechanism 16 itself. For example, the actuator 16a may be advanced to engage cam profile 58b with roller roller 60 during the first 85% of the targeted life of the latch 16 following path 59b, causing a normal overtravel of the ratchet 40. Whereas actuator 16a may be further advanced following path 59c to engage profile 58c with roller 60 should the pawl 42 not be detected to have engaged the ratchet 40 during 85% to 90% of the lift of the latch 16. Similarly, actuator 16a may be further advanced following path 59d to engage progressively increasing profile 58c with roller 60 should the pawl 42 not be detected to have engaged the ratchet 40 during 90% to 95% of the life of the latch 16. Similarly actuator 16a may be further advanced following path 59e to engage profile 58c with roller 60 should the pawl 42 not be detected to have engaged the ratchet 40 during 95% to 110% of the life of the latch 16. Accordingly a variable cinch overtravel may be provided, which may be in one possible configuration be in response to the primary pawl 42 being detected to having been moved into a locking position with the ratchet 40. In another possible configuration, the actuator 16a may be further advanced based on the life stage of the latch 40, for example based on a predetermined overtravel position correlated to time or cycle count. Thus the final overtravel positions of the ratchet 40 may be variable, such as increased, accordingly. It is recognized that the final overtravel may also be reduced accordingly depending on tolerances of latch components, or tolerances in the pop-up spring, or tolerances in the closure seals, or variations due to temperature as non-limiting examples. Any extra over travel or safety margin that would use exponentially increasingly difficult compression of the spring 39 and seal loads can be inhibited in the latch 16 configuration, thus facilitating the motor and gear train 80 (see FIGS. 18, 19) output to be reduced. Also shown is a reverse region RR, in which the actuator 16a is reversed after primary pawl 42 engagement is detected until the home position notch 70 is reached. The notch 70 facilitates the cinch lever 52 to disengage from the ratchet 40 while the ratchet 40 is held by the pawl 42 in order to provide for the extension member 54a to rotate into position with the ratchet 40. FIG. 14 shows an example operational diagram of the operational direction 72 of the actuator 16a for the cinch operation of the example cinch cam 50 of FIG. 13. For example, shown are the positions for Cinch start Cs, Variable overtravel zone OTz, primary pawl engagement detected position PPE (where the motor is reversed) and motor stopped at home position MSH.

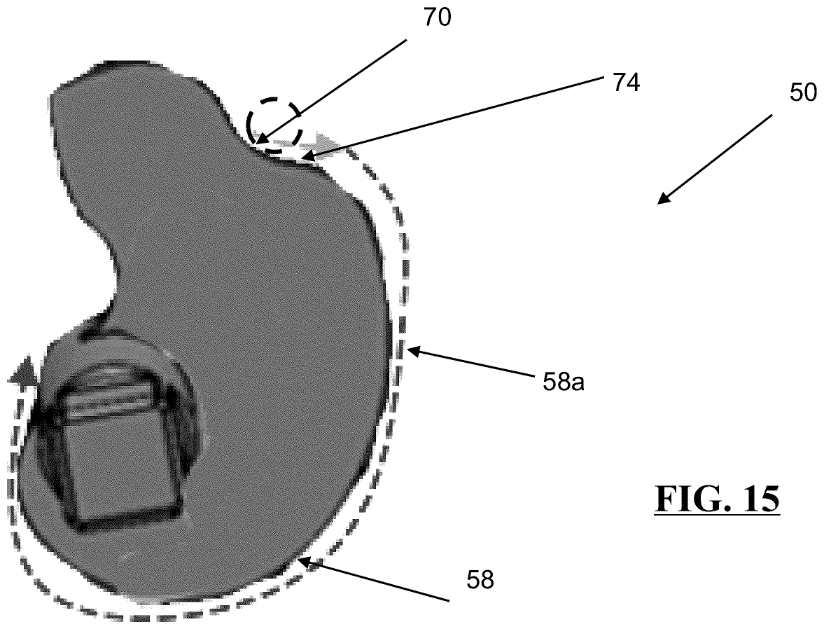

Referring to FIG. 15, shown is the cinch cam 50 with the cam surface 58 used for the release cycle operation (see FIG. 7). Further, the presence of a ramp 74 out of cam notch 70, can provide for over travel prior to release. The over travel for the release does not start from the end of cinch (secondary) cinch surface 58b, which is variable, and can provide a smaller over travel distance of the ratchet 40 (advantageously using less motor output used to compress the spring 39 and seal loads). Thus the amount of over travel for release can be consistent over the life of the latch mechanism 16, while the roller 60 can be advanced further over the secondary cinch surface 58a as needed to facilitate sufficient over travel is obtained so that the primary pawl 42 is engaged. As such, less torque is used in this arrangement, which provides for operation of the actuator 16a to move the ratchet 40 to the over travel position more rapidly as the roller 60 does not have to roll over the cinch surface 58 beyond the notch 70. Further, it is recognized that the primary cinch surface 58a shape profile of the cinch cam 58 can be used to define pop-up ratchet 40 speed control after the pawl 42 release.

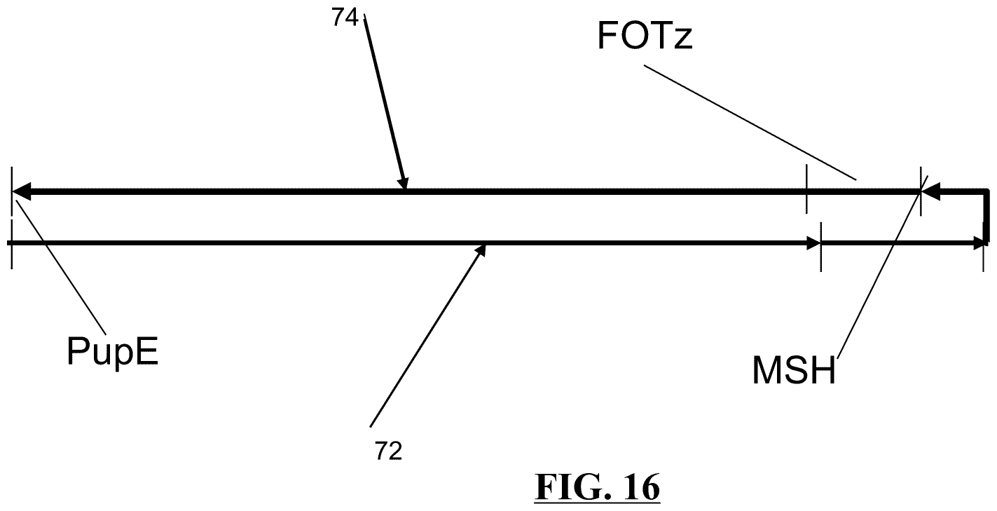

FIG. 16 shows an example operational diagram of the operational direction 72 of the actuator 16a for the cinch operation of the example cinch cam 50 of FIG. 15, as well as a speed control/anti-pop up zone 74. Shown by example are a pop-up control end PupE, a Fixed Over travel zone FOTz and the position where he motor is started from the home position MSH.

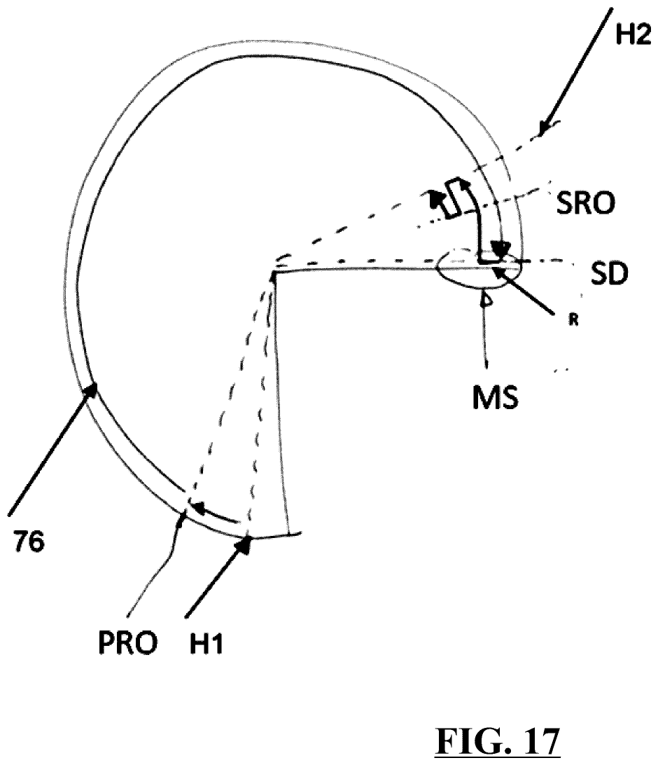

FIG. 17 shows an example actuator 16a rotation 76 during the release cycle operation starting from the primary home position, noting two distinct home positions H1 (primary home) and H2 (pop-up home) before full release. During a primary release operation PRO, the rotation will start from a first home position H1 and stop at a second home position H2 during which only the primary pawl has been released. Illustratively, when rotating from the first home position H1 to the second home position H2, the actuator 16a rotation reverses direction shown at R and is stopped at second home position H2. From the second home position H2, the actuator 16a is again rotated in the counterclockwise direction when referring to FIG. 17 to perform a secondary release operation SRO before returning to the second home position H2.

In other words, the primary and secondary release operation is not completed without either/both of actuator 16a stoppage, or a reversal in direction of the actuator 16a. Such two distinct control operations ensures a single motor function may not inadvertently cause also a secondary release in the event the motor is not stopped before causing a secondary release. Illustratively, the cam 50 is rotated over 270 degrees for performing the cinch, overtravel and pop-up speed reduction functions, but other ranges are possible depending on the seal load and system kinematics.

Since the overtravel for release operation consists of 50% of the use of the motor 16a, overall wear, tear, and strain on the motor can be reduced increasing life cycle and durability. Alternatively, a smaller, less costly motor 16a may be selected capable of handling the cinch overtravel for the other 50% of the usage of the motor 16a. Alternatively, less torque reduction may be required to increase cinch and release function speed. Any of the above design considerations may be balanced accordingly. Also shown by example is a snowload disengagement position SD. Further, shown in the diagram is a region MS where the motor stops and reverses before the second release by facilitating that there is no continuous release of the latch (1^{st} and 2^{nd} releases) in the same motor direction.

Referring to FIG. 18, shown is a front side of a release mechanism 5 of the latch system 9. FIG. 19 shows a back side of the release mechanism 5. The cinch cam 50 is connected to and thus driven off of a 3rd stage gear 82 and a release cam 84 is connected to and thus driven off of a 2nd stage gear 86. This example configuration of the gear train 80 can be used to better match load and speed needs during each of the cycles (e.g. cinch and release cycle operations of FIG. 7). To facilitate this, the gear train 80 can incorporate a timing gear 88 that controls the position of actuator release levers 90, so that release is only possible in specific actuator 16a positions. The gear train 80 configuration can also incorporate an actuator memory lever 92 that can inhibit the latch mechanism 16 from completely opening from both primary and secondary positions in a single activation, thus helping to preserve safety aspects of the double pull release mechanism 5.

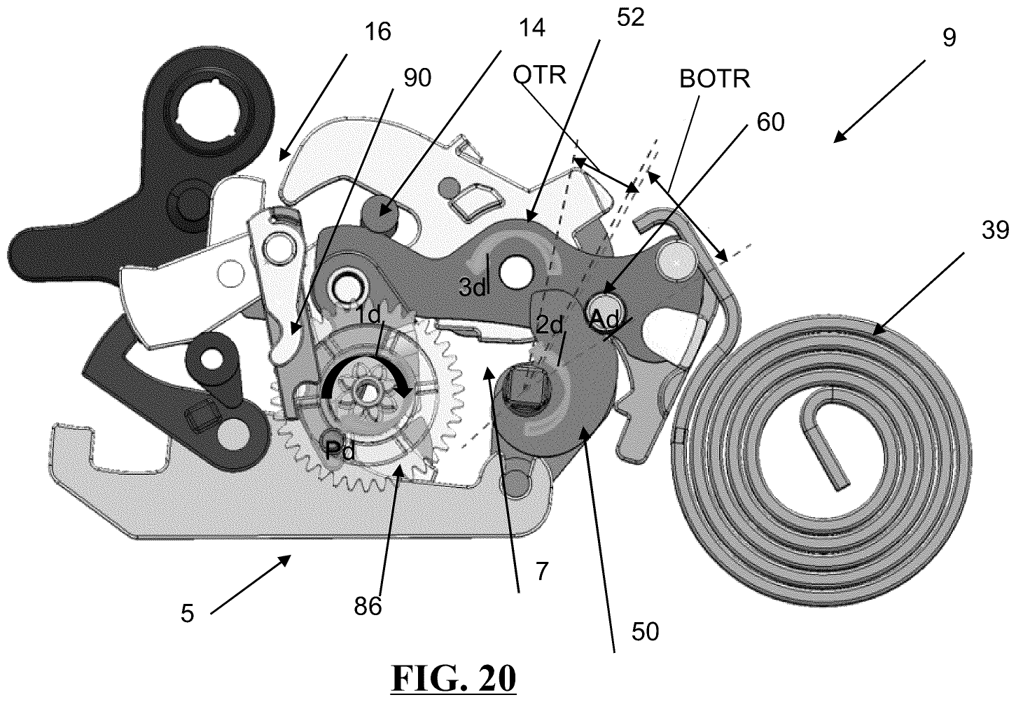

Referring to FIGS. 20-25 summarizing the primary release cycle operation, FIG. 20 shows the start of the primary release cycle operation, with the latch mechanism 16 in the primary position. At the first step shown by arrow indicated by reference 1d, the actuator 16a rotates the second stage gear 86 so that a pin at point Pd (mounted to the second stage gear 86) approaches the actuator release levers 90. The actuator release levers 90 are held in position by a cam profile on a timing gear cam 94 (see FIG. 19). At the second step shown by arrow indicated by reference 2d, the actuator 16a rotates the cinch cam 50 (which is connected to the third stage gear 82), which contacts the lift lever roller 60 at point Ad. At the third step shown by arrow indicated by reference 3d, due to the shape of the cinch cam 50, the lift lever 52 rotates in the over travel position, thus removing the pop up spring 39 load from the striker 14. Also shown are the cinch overtravel range OTR, the release backout/lost motion range BOTR, thus providing for a pop-up speed reduction range.

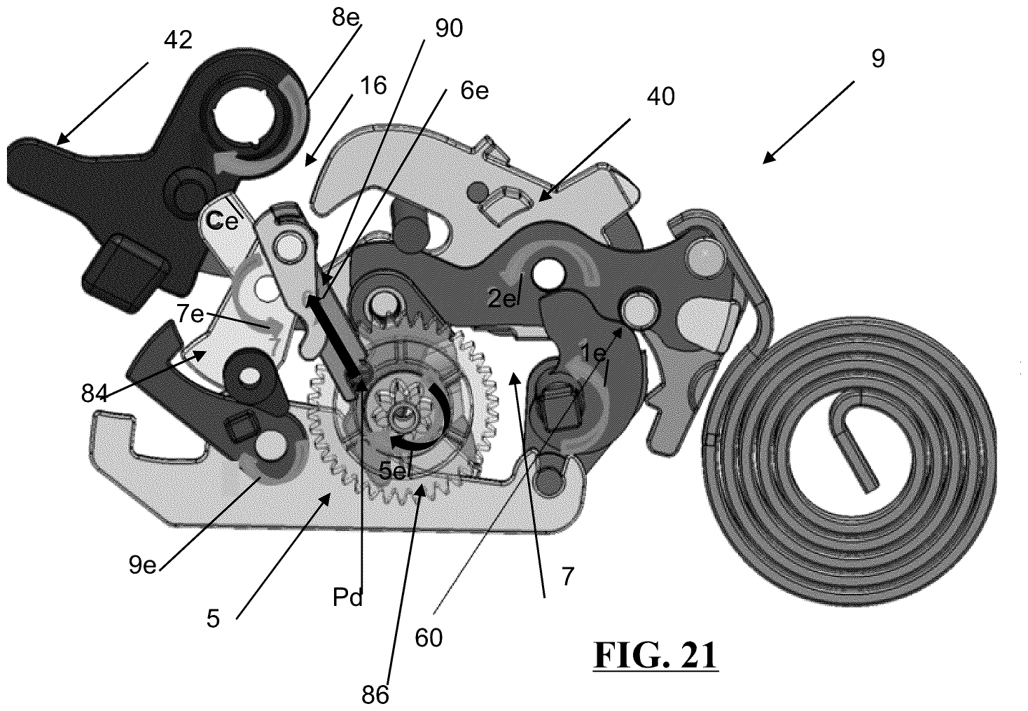

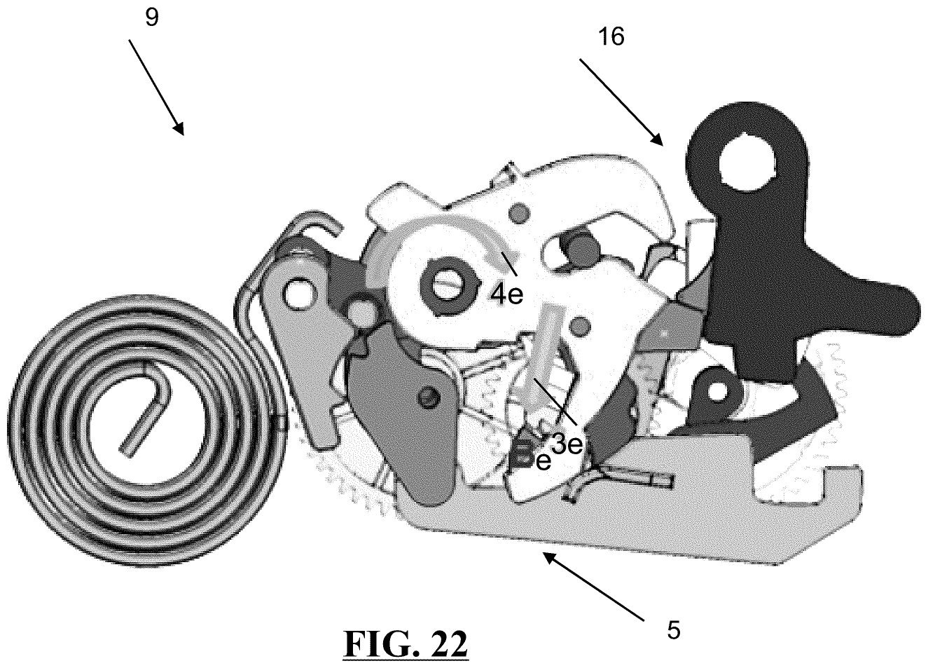

Referring to FIGS. 21 and 22, the primary release cycle operation continues. At the first step shown by arrow indicated by reference 1e, as the actuator 16a continues to rotate, the cinch cam 50 defines the position of the lift lever 52 by the profile of the cam surface 58. At the second step shown by arrow indicated by reference 2e, the lift lever 52 rotates slightly into the over travel position. At the third step shown by arrow indicated by reference 3e, the longer engagement step 54a of the cinch pawl 54 contacts the ratchet at point Be. At the fourth step shown by arrow indicated by reference 4e, the ratchet 40 rotates slightly into the over travel position in order to remove a seal/contact load from the interface between the ratchet 40 and the primary pawl 42. It is noted that the seal load between the Ratchet 40 and Primary Pawl 42 is taken up by the actuator 16a before the primary pawl 42 is released. The over travel for release occurs when the roller 60 is cammed out of the notch 70. The roller 60 does not travel again over the cinch over travel region during over travel release. The less aggressive over travel cam region (see FIGS. 13,15 is compensated for by the extension 54a in the cinch pawl 54. Since the roller 60 follows a shorter distance along the cam surface 58 compared to the cinch process, the pop-up (release cycle operation) of the closure panel 13 can occur more rapidly than the corresponding cinching during the cinch cycle operation, which is beneficial if a user is waiting for the closure panel 13 to open. The travel of the lift Lever 52 for pop up reduction is then controlled by the position of the cinch cam 50 thereafter. This operation described can facilitate the desired functionality of inhibiting or otherwise reducing typical pop-up noise of the closure panel 13 when released from the cinched position.

At the fifth step shown by arrow indicated by reference 5e, such that the pin Pd on the second stage gear 86 rotates into engagement with the actuator release levers 90. At the sixth step shown by arrow indicated by reference 6e, pin Pd pushes on the internal actuator release levers 90. At the seventh step shown by arrow indicated by reference 7e, the release levers 90 rotate the release cam 84 which in turn contacts the primary pawl 42 at contact point Ce. At the eighth step shown by arrow indicated by reference 8e, the primary pawl 42 rotates out of engagement with the ratchet 40. At the ninth step shown by arrow indicated by reference 9e, the actuator memory lever 92 engages with the release cam 84 holding the primary pawl 42 in the open position.

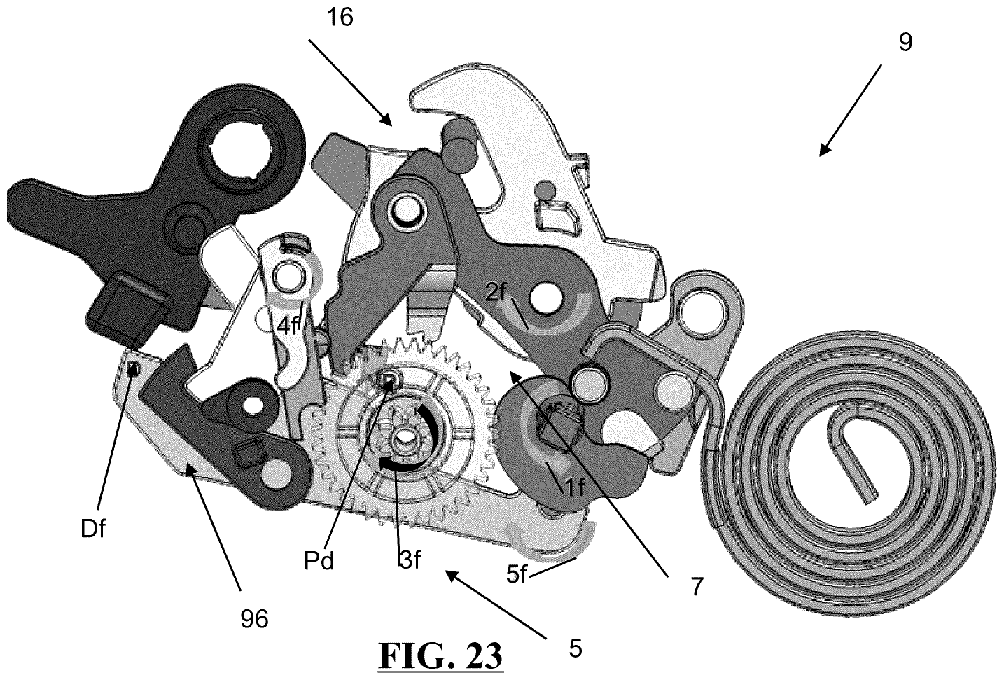

Referring to FIG. 23, the primary release cycle operation continues. At the first step shown by arrow indicated by reference 1f, the cinch cam 50 continues to rotate in order to control the position of the lift lever 52. At the second step shown by arrow indicated by reference 2f, the lift lever 52 slowly rotates to lift the striker 14 to the pop-up position. At the third step shown by arrow indicated by reference 3f, the second stage gear 86 continues to rotate. At the fourth step shown by arrow indicated by reference 4f, the actuator release leers 90 move out of the path of the pin Pd, based on the profile on the timing gear cam 94, thus facilitating the second stage gear 86 to freewheel for a number (e.g. several) of rotations. At the fifth step shown by arrow indicated by reference 5f, as the ratchet 40 moves up with the lift level 52 and the striker 14, the connecting lever 96 is able to rotate up and rest on the primary pawl 42 at point Df.

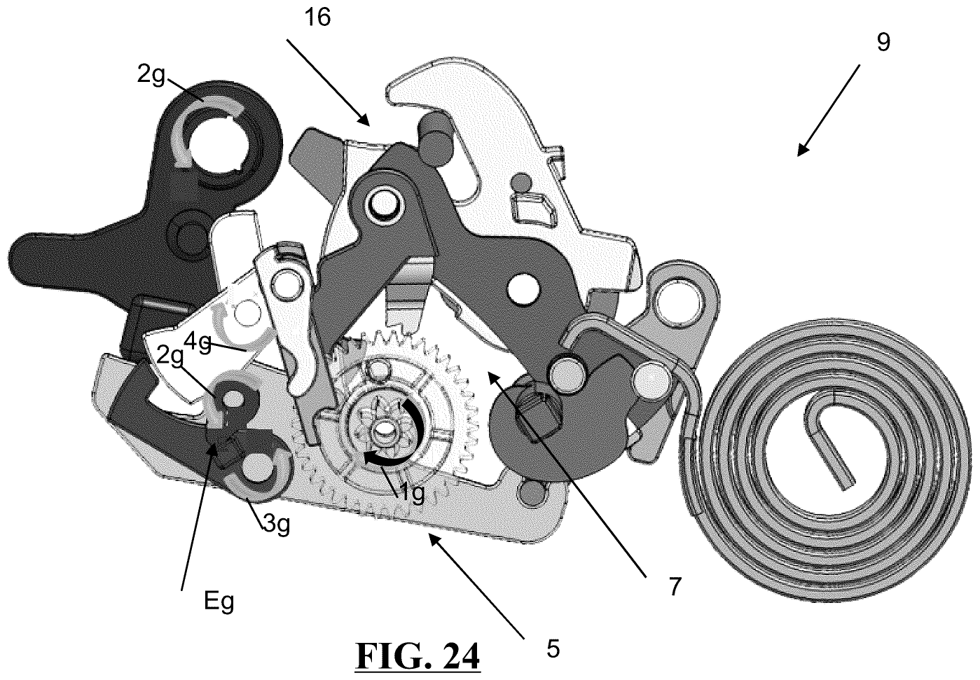

Referring to FIG. 24, the primary release cycle operation continues. At the first step shown by arrow indicated by reference 1g, the second stage gear 86 continues to rotate and the pin Pd bypasses the actuator release levers 90. At the second step shown by arrow indicated by reference 2g, the timing gear cam 94 (keyed to the timing gear 88) rotates and contacts the actuator memory lever 92 at point Eg. At the third step shown by arrow indicated by reference 3g, the actuator memory lever 92 rotates out of engagement with the release cam 84. At the fourth step shown by arrow indicated by reference 4g, the release cam 84 rotates out of engagement with the primary pawl 42. At the fifth step shown by arrow indicated by reference 5g, the primary pawl 42 rotates into the engaged position.

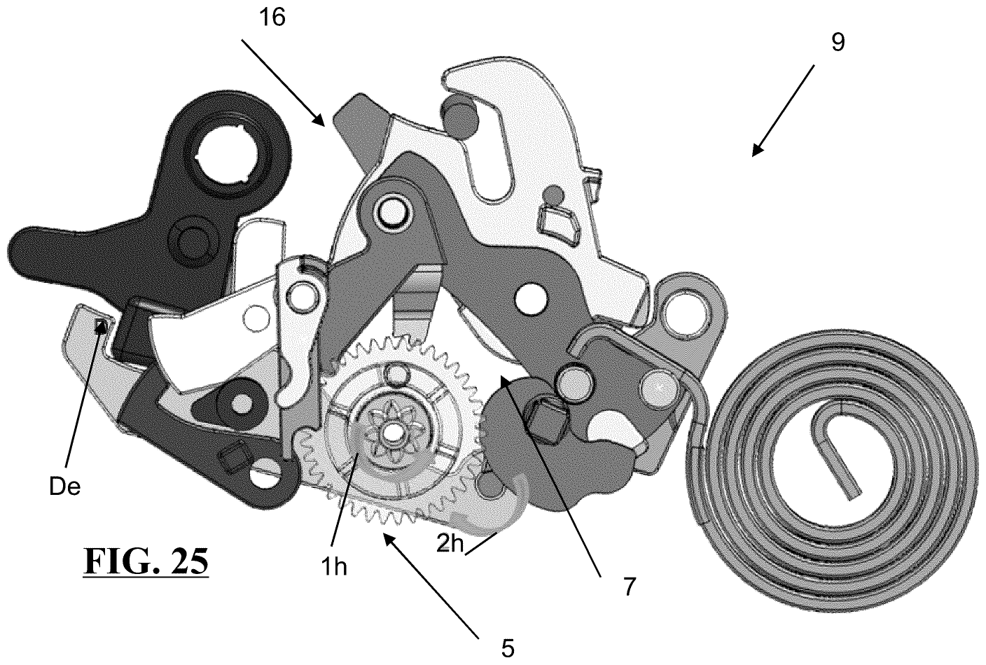

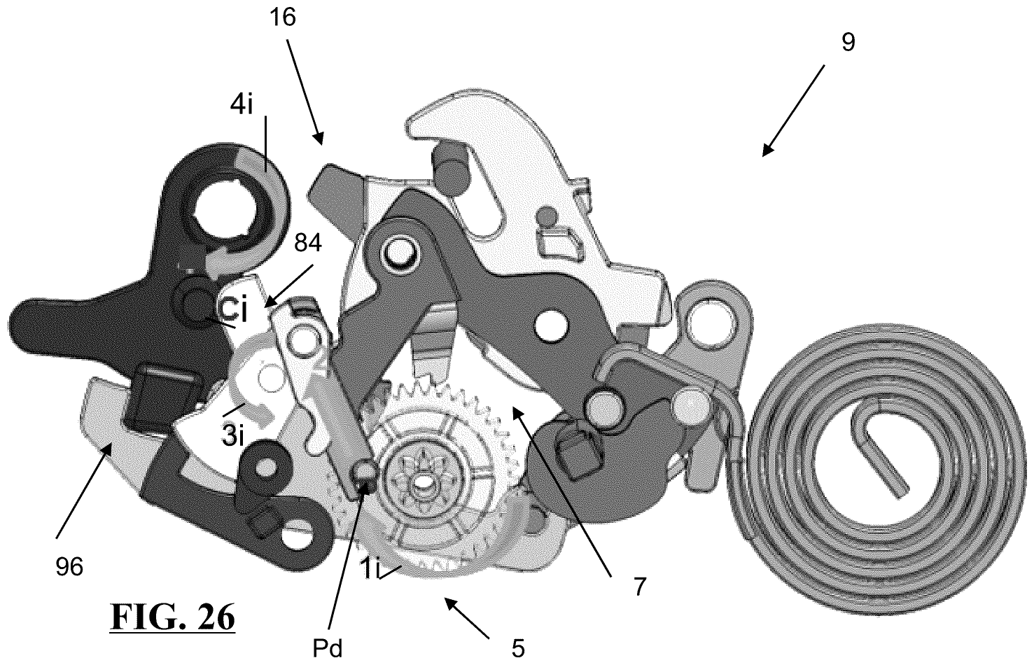

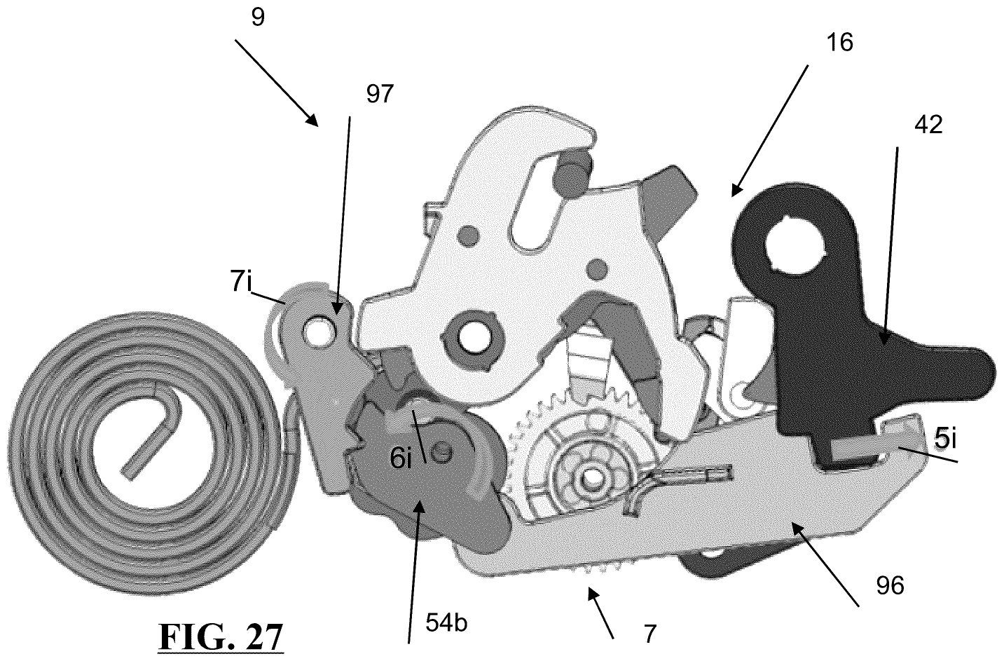

Referring to FIG. 25, the primary release cycle operation continues. At the first step shown by arrow indicated by reference 1h, the actuator 16a reverses direction and returns to the home position. At the second step shown by arrow indicated by reference 2h, the connecting lever 96 engages with the primary pawl 42 at point De, now ready for a secondary release function of the release cycle operation shown in FIG. 7. In this manner, the actuator 16a is stopped in order to provide that the continuous actuator 16a rotation does not release the first pawl 42 and the second pawl 54b (see FIG. 19) during a single actuation/rotation of the second stage gear 86. In other words, two separate rotations, for example in opposite directions are required in order to fully release the latch 16 i.e. to release both the primary 42 (via a first actuation direction) and secondary pawls 54b (via a second, and optionally opposite actuation direction) of latch 16. Referring to FIGS. 26, 27, an example embodiment of the secondary release cycle operation is shown. At the first step shown by arrow indicated by reference 1i, the second stage gear 86 rotates and the pin Pd engages with the actuator release levers 90. At the second step shown by arrow indicated by reference 2i, the pin Pd pushes on the internal actuator release levers 90. At the third step shown by arrow indicated by reference 3i, the release levers 90 rotate the release cam 84 which in turn contacts the primary pawl 42 at point Ci. At the fourth step shown by arrow indicated by reference 4i, the primary pawl 42 rotates to the open position. At the fifth step shown by arrow indicated by reference 5i, the primary pawl 42 pulls on the connecting lever 96. At the sixth step shown by arrow indicated by reference 6i, the connecting lever 96 rotates the secondary pawl 54b out of engagement with the ratchet 40. At the seventh step shown by arrow indicated by reference 7i, the memory lever 97 (see FIG. 19) engages with the secondary pawl 54b.

In view of the above, the cinch cam 50 is driven off the third stage gear 82 and the release cam 84 off of the second stage gear 86, in order to advantageously mathf the load and speed needs during each of the different cinch/release cycle operations shown in FIG. 7. The configuration of the cinch mechanism 7 and the release mechanism 5 incorporates a timing gear 88 to control the position of the actuator release levers 90 so that release is only possible, i.e. limited, in selected/designated actuator positions. The configuration also can incorporate an actuator memory lever 92 that inhibits the latch mechanism 16 from completely opening from both the primary and secondary positions in a single activation, preserving the safety aspects of a desired double pull and thus two stage (e.g. primary and secondary) release operation.

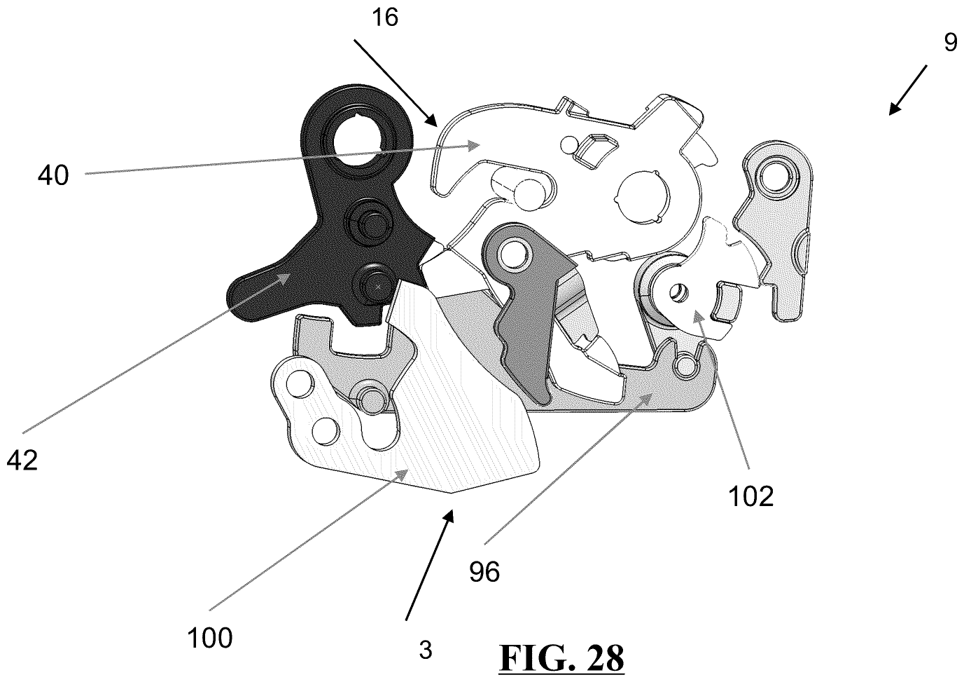

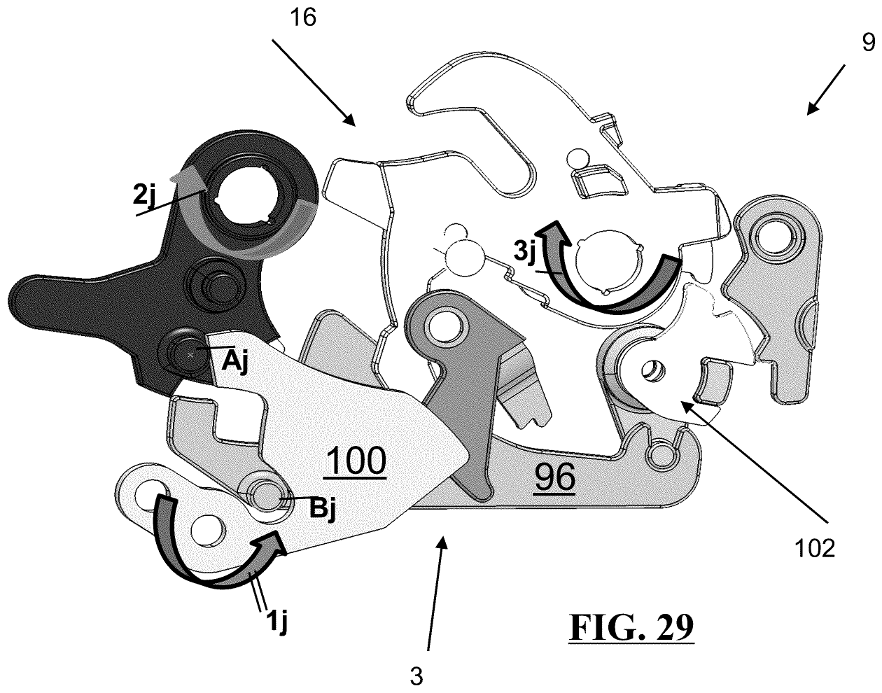

Referring to FIGS. 28-29, a service release mechanism 3 is described. The service release mechanism 3 has a service release lever 100 for coupling with a primary pawl 42. Further, the service release mechanism 3 makes use of the connecting lever 96 as well as a secondary pawl 102, as further described below. The service release lever 100 interacts with both the Primary Pawl 42 and the Connecting Lever 96. In normal conditions, the Service Release lever 100 acts directly on the Primary Pawl 42. In the event that the Primary Pawl 42 is preloaded, the Connecting Lever 96 is held in a position that allows it to be released directly with the Service Release lever 100. Again, this maintains the safety advantage of a double pull latching system 9.

In operation for a primary release using the service lever 100, in the first step indicated by the reference 1j, the service lever 100 is rotated and thus transfers load to the primary pawl 42 at contact point Aj. Thus no substantive contact with the connecting lever 96 at point Bj and no movement of the secondary pawl 102 is done. In the second step indicated by the reference 2j, the primary pawl 42 is thus rotated out of engagement with the ratchet 40. In the third step indicated by the reference 3j, the ratchet 40 is thus free to rotate up into the secondary latch position.

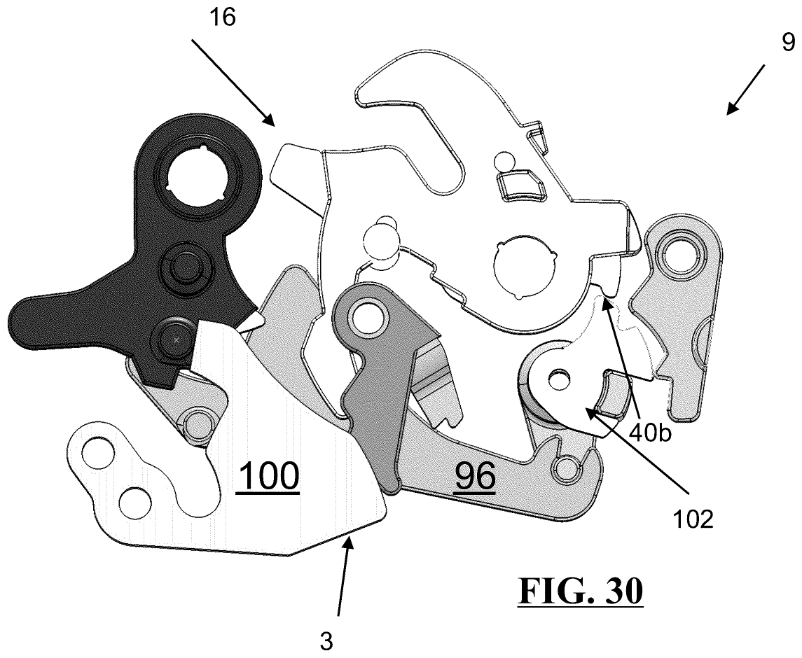

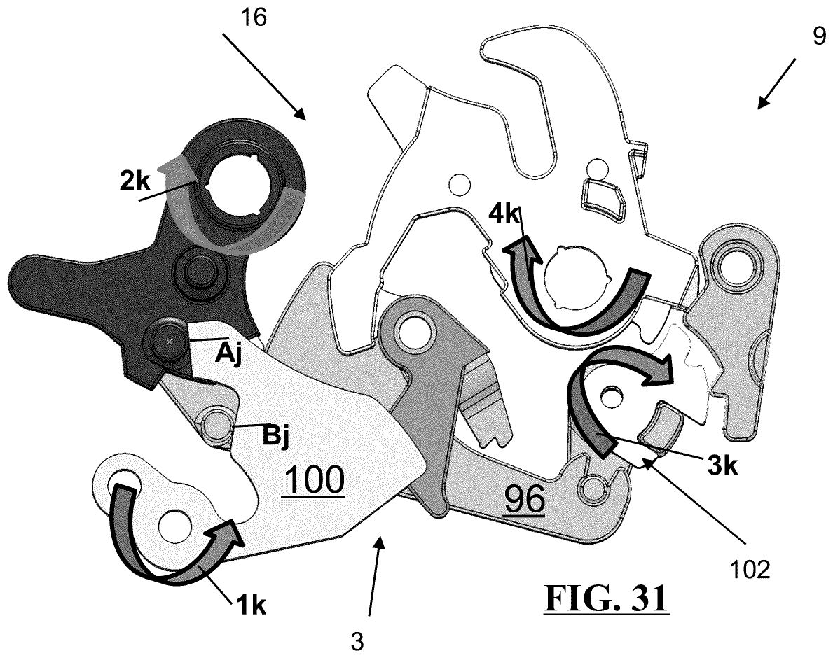

FIG. 30 shows the latch mechanism 16 in the secondary position. FIG. 31 shows operation of the secondary release of the latch mechanism 16 from the secondary position shown in FIG. 30, using the service release mechanism 3. In operation for a secondary release using the service lever 100, in the first step indicated by the reference 1k, rotate the service lever 100 and transfer load to the primary pawl 42 at contact point Aj, which can include possible simultaneous contact with connecting lever 96 at point Bj. In the second step indicated by the reference 2k, the primary pawl 42 rotates and pulls on the connecting lever 96. In the third step indicated by the reference 3k, the connecting lever 96 rotates the secondary pawl 102 out of engagement with the ratchet 40. In the fourth step indicated by the reference 4k, the ratchet 40 is free to rotate to the open position and thus the latch mechanism 16 is considered unlatched/unlocked.

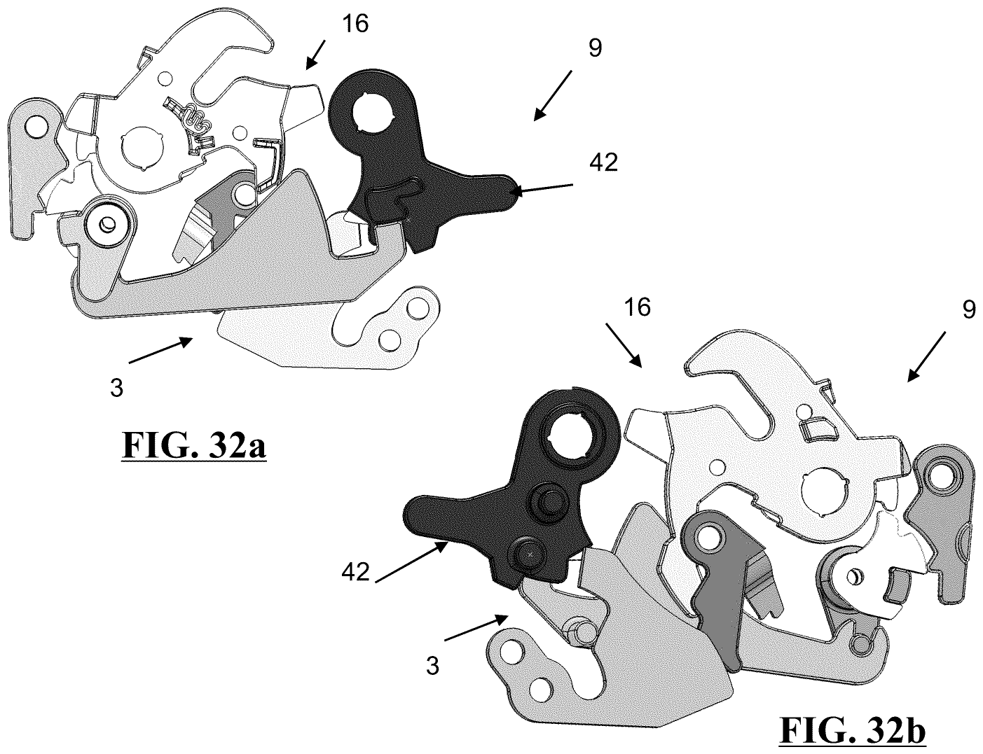

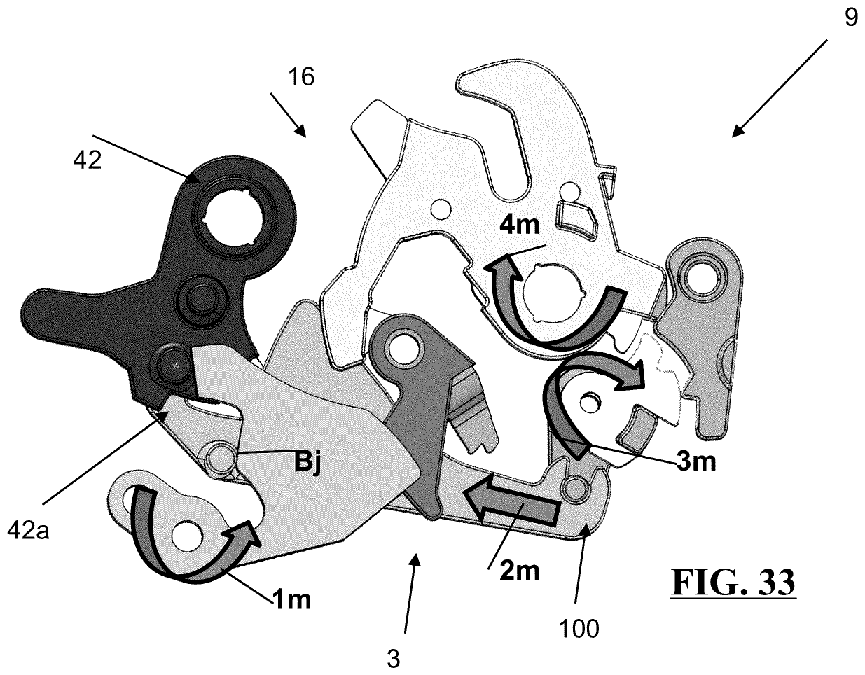

FIGS. 32aa,b, 33 show the latch mechanism 16 in the secondary position, such that the primary pawl 42 is in a pre-loaded condition. In operation for a secondary release using the service lever 100 in which the primary pawl 42c is preloaaded, in the first step indicated by the reference 1m, rotate the service lever 100 and transfer the load to the connecting lever 96 at contact point Bj. In the second step indicated by the reference 2m, the connecting lever 96 moves linearly to rest on an abutment 42a of the primary pawl 42. In the third step indicated by the reference 3m, the connecting lever 96 rotates the secondary pawl 102 out of engagement with the ratchet 40. In the fourth step indicated by the reference 4m, the ratchet 40 is free to rotate to the open position and thus the latch mechanism 16 is considered unlatched/unlocked.

In view of the above, the service release lever interacts with both the primary pawl and the connecting lever. In normal conditions, the service release lever acts directly on the primary pawl. In the event that the primary pawl 42 is preloaded, the connecting lever is held in a position that facilitates it to be released directly with the service release lever. Again, this helps to maintain the safety advantage of a double pull latch mechanism 16.

In view of the above, the latch system 9 provides for controlled release of stored pop-up energy without the need for excessive cinch over travel, recognizing that excessive and consistent/fixed cinch over travel is the current norm in the industry. Further, the cinch overtravel is variable and may be a function of the pawl 42 engagement with the ratchet 40. Further, the overtravel during the release cycle is less than that during the cinch cycle, in order to reduce the load on the actuator during the release operation. Further, reduction in the cinch overtravel and the release overtravel allows the introduction of increased seal loading improving the sealing of the closure panel, such as increased sealing for a Frunk. Further, the release mechanism 5 operates off of a lower gear ration that the cinch mechanism, in order to help optimize speed and provide for anti pop-up features (undesirable speed of release and/or noise). The release mechanism 5 also helps to maintain the double pull function of the latch mechanism 16 to inhibit any unintended full release of the latch mechanism 16 in a single stage release operation. Further, a service release strategy is used that can work in all latch mechanism 16 positions, regardless if the actuator 16a and/or pawl 42, 54, 54b are not in their respective home position(s). Further, the pop-up spring 39 configuration provides for a flatter load curve to help reduce engagement effort and to maximize cinch load capability.

In view of the various mechanisms 3,5,7,16 of the latching system, various aspects included are as follows: 1) a latch system 9 having two different over travel motions and/or travel positions for cinch cycle operation compared to release cycle operation; 2) a latch system 9 having a variable over travel position for a cinch function and a fixed release over travel for a release function; 3) a latch system 9 having a two position cinch lever 52 (extension activated in release over travel to help reduce the over travel during release); 4) a latch system 9 having a non-symmetrical ratchet position control during cinch and release modes; and 5) a service release lever system 3 that moves both the primary pawl 42 and a connecting lever 96.

In view of the above, it is considered advantageous if one can reduce the amount of over travel during cinch so that the latching system 9 can be configured with either a smaller motor/actuator 16a or less gear reduction or increased seal load/larger pop-up spring. Also if one does not want to have a system that can over cinch to primary, then this is a problem since the latch may in certain circumstances undesirably fail to engage in the primary position, e.g. this could happen over time due to wear. It is recognized that this can be less of a problem for over travel during release cycle operation because the pawl 42 could always be forcibly moved, just leading to a larger opening sound. But if the cinch lever 52 can't urge the ratchet 40 to primary position due to wear over time, the latch could become inoperable. So the described latching system 9 has a variable cinch range which increases over time to facilitate the latch can still cinch, even under wear conditions.

We claim:

1. A latching system (9) for facilitating opening and closing of a closure panel (13) of a vehicle (11), the actuation system comprising:
a latch mechanism (16); and
a cinching mechanism (7).

2. The latching system of claim 1 further comprising an anti-pop-up feature including a lever (52) for limiting over travel of the latch mechanism in order to provide a controlled release of stored pop-up energy.

3. The latching system of claim 2 further comprising a cam used to control operation of a lift lever of the cinching mechanism.

4. The latching system of claim 1 further comprising: the cinching mechanism employing a first gear ratio; and a release mechanism (5) employing a second gear ratio; wherein the first gear ratio is higher than the second gear ratio in order to obtain different speed of operation between a release operation and a cinching operation.

5. The latching system of claim 4 further comprising a cam used to control operation of a lift lever of the cinching mechanism.

6. The latching system of claim 4 further comprising an actuator memory lever for inhibiting an unintended release of the latch mechanism from both a primary position and a secondary position.

7. The latching system of claim 1 further comprising: a pop-up spring (39) coupled to the cinching mechanism in order to provide a first moment arm and a second moment arm, the first moment arm different from the second moment arm in order to reduce engagement effort of the latch mechanism while increasing load capability of the cinching mechanism.

8. The latching system of claim 7, wherein a center of the pop-up spring is positioned off center from a pivot point of a lift lever of the cinching mechanism.

9. The latching system of claim 1 further comprising:
a release mechanism (5); and
a service release mechanism (3) coupled to the release mechanism;
wherein the service release mechanism is configured to operate in multiple latch positions irrespective of one or more latch components being outside of their respective home position.

10. The latching system of claim 1 further comprising:
the latch mechanism having a ratchet, the ratchet moveable between an overtravel position, a latched position and a released position; and
the cinching mechanism adapted to move the ratchet to the overtravel position, wherein the overtravel position is variable.

11. The latching system of claim 10 further comprising: a pop-up spring (39) coupled to the cinching mechanism in order to provide a first moment arm and a second moment arm, the first moment arm different from the second moment arm in order to reduce engagement effort of the latch mechanism while increasing load capability of the cinching mechanism.

12. The latching system of claim 11, wherein a center of the pop-up spring is positioned off center from a pivot point of a lift lever of the cinching mechanism.

13. The latching system of claim 1 further comprising:
a ratchet, the ratchet moveable between a cinch overtravel position, a release overtravel position, a latched position and a released position;
a pawl moveable between a ratchet holding position and a ratchet releasing position; and
a motor adapted to move the ratchet to the cinch overtravel position during a cinching mode and adapted to move the pawl from the ratchet holding position to the ratchet releasing position and move the ratchet to the release overtravel position during a releasing mode;
wherein the release overtravel position is less than the cinch overtravel position.

14. The latching system of claim 13 further comprising an anti-pop-up feature including a lever (52) for limiting over travel of the latch mechanism in order to provide a controlled release of stored pop-up energy.

15. The latching system of claim 14 further comprising a cam used to control operation of a lift lever of the cinching mechanism.

16. The latching system of claim 13 further comprising an actuator memory lever for inhibiting an unintended release of the latch mechanism from both a primary position and a secondary position.

17. The latching system of claim 1 further comprising:
a ratchet adapted to engage a striker, the ratchet having a released position, a locked position, and an overtravel position;
a pawl adapted to hold the ratchet in the locked position or release the ratchet from the locked position; and
an actuator adapted to rotate the ratchet to the overtravel position,
wherein actuator causes the rotation profile of the ratchet during a cinch mode that is different than the rotation profile of the ratchet during a power release mode.

18. The latching system of claim 17 further comprising an anti-pop-up feature including a lever (52) for limiting over travel of the latch mechanism in order to provide a controlled release of stored pop-up energy.

19. The latching system of claim 18 further comprising a cam used to control operation of a lift lever of the cinching mechanism.

20. The latching system of claim 17, wherein the closure panel is for a frunk compartment.
